(19) United States
(12) Patent Application Publication
(10) Pub. No.: US 2025/0278736 A1
(43) Pub. Date: Sep. 4, 2025

(54) DEVICES, METHODS, COMPUTER-READABLE MEDIA, AND SYSTEMS WITH AUTHORIZED FRAUD DETECTION

(71) Applicant: MASTERCARD TECHNOLOGIES CANADA ULC, Vancouver (CA)

(72) Inventors: Sik Suen Chan, Richmond (CA); Nikolay Shenkov, Burnaby (CA); Yimeng Li, Vancouver (CA); Jonathan McGrandle, Maple Ridge (CA)

(21) Appl. No.: 19/068,820

(22) Filed: Mar. 3, 2025

Related U.S. Application Data
(60) Provisional application No. 63/561,121, filed on Mar. 4, 2024.

(51) Int. Cl. G06Q 20/40

(52) U.S. Cl. CPC G06Q 20/4016

(57) ABSTRACT

Devices, methods, computer-readable media, and systems with authorized fraud detection. In one example, a device may include a memory including an input profile record (IPR) repository and a non-input profile record (non-IPR) information repository that is distinct from the IPR repository, and an electronic processor in communication with the memory. The electronic processor is configured to receive a current IPR associated with a user entering information to transfer electronic funds, detect that the user is performing authorized fraud based on the current IPR, and responsive to detecting that the user is performing authorized fraud based on the current IPR, output a control signal indicating that the user is performing authorized fraud.

### FIELD

The present disclosure relates generally to fraud detection. More specifically, the present disclosure relates to devices, methods, computer-readable media, and systems with authorized fraud detection.

### BACKGROUND

Conventionally, fraud detection occurs in a variety of different ways, and in particular, by identifying authorized users of a particular account or resource. For example, a user may be identified with individual or combinations of distinctive biometrics that are associated with the user. In a different example, a user may be identified after receiving a one-time password to a registered user device associated with the user.

### SUMMARY

However, a fraudulent operation may still occur even when an authorized user of a particular account or resource is performing the fraudulent operation because the fraudulent operation is at the behest of a bad actor. For example, an authorized user of a particular account or resource may receive an electronic message requesting electronic funds be sent to a second account that is not controlled by the authorized user. The authorized user may assume or not understand that the request is a fraudulent request. When the authorized user transfers the electronic funds to the second account, conventional fraud detection techniques struggle to detect this fraudulent transfer because the authorized user is the one performing the transfer. Put simply, there is a problem of authorized users inadvertently performing fraudulent operations, which is challenging to detect because it is the authorized user performing the operation. This problem is referred to as “authorized fraud.”

The present disclosure improves upon the conventional fraud detection techniques and solves the aforementioned problem by detecting various features that are specific to authorized fraud (e.g., features that are indicative of uncertainty or doubt about the transaction). The present disclosure detects these various features with the following: an input profile record (IPR), non-IPR information, or a combination of IPR and non-IPR information.

The input profile record is based on a plurality of user inputs of a user and the input profile record changes over time. The input profile record may then be continuously used to identify the user's use of any device over time. Further, derivation of biometric features (e.g., user hesitancy) from the generated IPRs are improvements over the conventional fraud detection techniques.

In some aspects, the examples described herein relate to a server including: a memory including an input profile record (IPR) repository, a non-input profile record (non-IPR) information repository that is distinct from the IPR repository, and an electronic processor in communication with the memory. The electronic processor is configured to receive a current IPR associated with a user entering information to transfer electronic funds, detect that the user is performing authorized fraud based on the current IPR, and responsive to detecting that the user is performing authorized fraud based on the current IPR, output a control signal indicating that the user is performing authorized fraud.

In some aspects, the examples described herein relate to a server including: a memory including an input profile record (IPR) repository, a non-input profile record (non-IPR) information repository that is distinct from the IPR repository, and an electronic processor in communication with the memory. The electronic processor is configured to receive non-IPR information associated with a user entering information to transfer electronic funds, detect that the user is performing authorized fraud based on the non-IPR information, and responsive to detecting that the user is performing authorized fraud based on the non-IPR information, output a control signal indicating that the user is performing authorized fraud.

In some aspects, the examples described herein relate to a server including: a memory including an input profile record (IPR) repository, a non-input profile record (non-IPR) information repository that is distinct from the IPR repository, and an electronic processor in communication with the memory. The electronic processor is configured to receive a current IPR and non-IPR information associated with a user entering information to transfer electronic funds, detect that the user is performing authorized fraud based on the current IPR and the non-IPR information, and responsive to detecting that the user is performing authorized fraud based on the current IPR and the non-IPR information, output a control signal indicating that the user is performing authorized fraud.

### BRIEF DESCRIPTION OF THE DRAWINGS

FIG. 1 is a block diagram illustrating a system with authorized fraud detection, in accordance with various aspects of the present disclosure.

FIGS. 2-4 are charts illustrating example IPRs with different IPR events, in accordance with various aspects of the present disclosure.

FIG. 5 is a chart illustrating IPR feature importance, in accordance with various aspects of the present disclosure.

FIGS. 6 and 7 are charts illustrating example non-IPR information, in accordance with various aspects of the present disclosure.

FIG. 8 is a chart illustrating transaction only feature importance, in accordance with various aspects of the present disclosure.

FIG. 9 is a chart illustrating transaction and destination feature importance, in accordance with various aspects of the present disclosure.

FIG. 10 is a chart illustrating example IPRs with different interaction based and time-based IPR events, in accordance with various aspects of the present disclosure.

FIG. 11 is a chart illustrating example IPRs with different mouse interaction IPR events, in accordance with various aspects of the present disclosure.

FIG. 12 is a chart illustrating example IPRs with different mouse interaction IPR events, in accordance with various aspects of the present disclosure.

FIGS. 13A and 13B are diagrams illustrating a hierarchical clustering to group an example of the large number of features together, in accordance with various aspects of the present disclosure.

FIG. 14 is a chart illustrating feature importance example when including IPR features with respect to a first of two different entities, in accordance with various aspects of the present disclosure.

FIG. 15 is a chart illustrating feature importance example when including IPR features with respect to a second of two different entities, in accordance with various aspects of the present disclosure.

FIG. 16 is a diagram illustrating plots of these new features (distance-based) and existing features (time-based) with respect to the example of FIG. 14, in accordance with various aspects of the present disclosure.

FIG. 17 illustrates plots of these new features (distance-based) and existing features (time-based) with respect to the example of FIG. 15, in accordance with various aspects of the present disclosure.

FIG. 18 is a flowchart illustrating a first example method for detecting authorized fraud, in accordance with various aspects of the present disclosure.

FIG. 19 is a flowchart illustrating a second example method for detecting authorized fraud, in accordance with various aspects of the present disclosure.

FIG. 20 is a flowchart illustrating a third example method for detecting authorized fraud, in accordance with various aspects of the present disclosure.

### DETAILED DESCRIPTION

Before any embodiments of the present disclosure are explained in detail, it is to be understood that the present disclosure is not limited in its application to the details of construction and the arrangement of components set forth in the following description or illustrated in the following drawings. The present disclosure is capable of other embodiments and of being practiced or of being carried out in various ways.

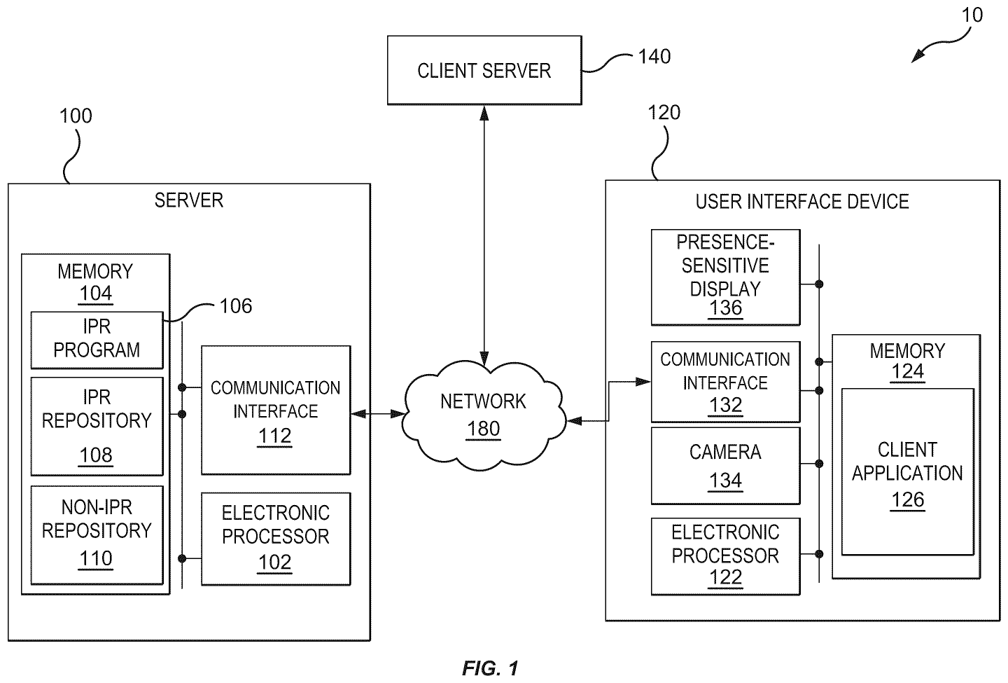

FIG. 1 is a block diagram illustrating a system 10 with user identification based on an input profile record, in accordance with various aspects of the present disclosure. It should be understood that, in some embodiments, there are different configurations from the configuration illustrated in FIG. 1. The functionality described herein may be extended to any number of servers providing distributed processing.

In the example of FIG. 1, the system 10 includes a server 100, a user interface device 120, a client server 140, and a network 180. The server 100 includes an electronic processor 102 (for example, a microprocessor or another suitable processing device), a memory 104 (for example, a non-transitory computer-readable storage medium), and a communication interface 112. It should be understood that, in some embodiments, the server 100 may include fewer or additional components in configurations different from that illustrated in FIG. 1. Also, the server 100 may perform additional functionality than the functionality described herein. In addition, the functionality of the server 100 may be incorporated into other servers. As illustrated in FIG. 1, the electronic processor 102, the memory 104, and the communication interface 112 are electrically coupled by one or more control or data buses enabling communication between the components.

The electronic processor 102 executes machine-readable instructions stored in the memory 104. For example, the electronic processor 102 may execute instructions stored in the memory 104 to perform the functionality described herein.

The memory 104 may include a program storage area (for example, read only memory (ROM)) and a data storage area (for example, random access memory (RAM), and other non-transitory, machine-readable medium). In some examples, the program storage area may store machine-executable instructions regarding an authorized fraud detection and mitigation program 106. In some examples, the data storage area may store data regarding an input profile record (IPR) repository 108 and a non-IPR information repository 110.

The authorized fraud detection and mitigation program 106 causes the electronic processor 102 to collect and store input profile records (IPRs) in the input profile record repository 108. The authorized fraud detection and mitigation program 106 also causes the electronic processor 102 to collect and store non-IPR information the non-IPR information repository 110. Specifically, the authorized fraud detection and mitigation program 106 causes the electronic processor 102 to parse the IPR content and the non-IPR received directly from a user interface device or indirectly from a client server, determine biometric features (e.g., based on the current IPR and historical/older IPRs associated with the user, non-IPR information, or a combination of both), and detect whether a user is performing authorized fraud using a biometric identification algorithm that compares current biometrics features to the historical biometric features.

In some examples, the authorized fraud detection and mitigation program 106 includes machine learning models that are trained on fraudulent IPR data, fraudulent non-IPR data, and/or fraudulent accounts. The authorized fraud detection and mitigation program 106 may use the machine learning models to determine the biometric features, for example, some or all of the features described and/or illustrated in FIGS. 5, 13, 14, and 13A-15. Additionally, the authorized fraud detection and mitigation program 106 may also use feedback data to further train the machine learning models to generate historical features per account.

In some examples, the authorized fraud detection and mitigation program 106 includes a cleaning component. Specifically, the cleaning component of the authorized fraud detection and mitigation program 106 may include cleaning fraud request labels, where there may be an issue with sessionid join or with an exact fraud request being labeled as fraud.

The authorized fraud detection and mitigation program 106 also causes the electronic processor 102 to update an input profile record stored in the input profile record repository 108. Additionally, the authorized fraud detection with the IPRs is a “passive” detection that does not need to query a user for additional information.

In some examples, the input profile record repository 108 is a central repository including a plurality of input profile records. Each input profile record is associated with a specific user (e.g., a user account) and/or a specific user interface device. An input profile record stored in the input profile record repository 108 is updated periodically with the authorized fraud detection and mitigation program 106 as described above. The input profile record associated with the user interface device 120 is indicative of an identity of a user over a specific period of time.

In some examples, the non-IPR information repository 110 is a central repository including a plurality of records that do not include IPR information (referred to as “non-IPR information” herein). Each piece of non-IPR information is associated with a specific user (e.g., a user account) and/or a specific user interface device. Non-IPR information stored in the non-IPR information repository 110 is updated periodically with the authorized fraud detection and mitigation program 106 as described above. The non-IPR information associated with the user interface device 120 is also indicative of an identity of a user over a specific period of time.

For example, the biometric algorithm of the authorized fraud detection and mitigation program 106 includes a number of typing and sensor behavioral features (also referred to as “biometric features”) from the user inputs (i.e., events included in the IPR data construct).

The communication interface 112 receives data from and provides data to devices external to the server 100, such as IPR data and non-IPR information from the client server 140 via the network 180. For example, the communication interface 112 may include a port or connection for receiving a wired connection (for example, an Ethernet cable, fiber optic cable, a telephone cable, or the like), a wireless transceiver, or a combination thereof. In some examples, the network 180 is the Internet.

In the example of FIG. 1, the user interface device 120 includes an electronic processor 122 (for example, a microprocessor or another suitable processing device), a memory 124 (for example, a non-transitory computer-readable storage medium), a communication interface 132, a camera 134, and a presence-sensitive display 136. In some examples, the user interface device may be a smartphone, tablet, laptop, or other suitable user interface device with a presence-sensitive display. As illustrated in FIG. 1, the electronic processor 122, the memory 124, the communication interface 132, the camera 134, and the presence-sensitive display 136 are electrically coupled by one or more control or data buses enabling communication between the components.

The electronic processor 122 executes machine-readable instructions stored in the memory 124. For example, the electronic processor 122 may execute instructions stored in the memory 124 to perform the functionality described herein.

The memory 124 may include a program storage area (for example, read only memory (ROM)) and a data storage area (for example, random access memory (RAM), and other non-transitory, machine-readable medium). The program storage area includes a user input collection and input profile record (IPR) application 126. In some examples, the user input collection and IPR application 126 may be a standalone application. In other examples, the user input collection and IPR application 126 is a feature that is part of a separate application (e.g., the user input collection and IPR application 126 may be included as part of a camera application, a banking application, or other suitable application).

The user input collection and IPR application 126 causes the electronic processor 122 to collect user inputs, i.e., user interactions, from a user relative to a mobile application (e.g., time to fill data field entries, use of specific autofill, or other suitable user inputs) of the user interface device 120 and generate an input profile record (IPR) based on the user inputs (also referred to as a “a mobile platform”). The user input collection and authorized fraud detection and mitigation program 106 may also cause the electronic processor 122 to collect user inputs at a particular website (e.g., time to fill data field entries, use of specific autofill, or other suitable user inputs) and generate (or update) the input profile record based on these user inputs (also referred to as a “web platform”).

In some examples, the user input collection and IPR application 126 causes the electronic processor 122 to collect user inputs with respect to the presence-sensitive display 136 (e.g., type of keyboard, typing speed, use of patterns, or other suitable user inputs). In these examples, the user input collection and IPR application 126 may also cause the electronic processor 122 to output the generated IPR to the server 100 via the communication interface 132 and the network 180. Additionally, in some examples, the user input collection and IPR application 126 may cause electronic processor 122 to control the memory 124 to store the user inputs that are collected and/or the IPR that is generated for a period of time or until the generated IPR is output to the server 100.

In other examples, the user input collection and IPR application 126 causes the electronic processor 122 to collect user inputs with respect to the camera 134 (e.g., facial recognition, user gestures, or other suitable user inputs, which may be part of the mobile platform. In these examples, the user input collection and IPR application 126 may also cause the electronic processor 122 to generate (or update) an IPR based on the aforementioned user inputs and output the IPR to the server 100 via the communication interface 132 and the network 180. Additionally, in some examples, the user input collection and IPR application 126 may cause electronic processor 122 to control the memory 124 to store the user inputs that are collected and/or the IPR that is generated for a period of time or until the generated IPR is output to the server 100.

The communication interface 132 receives data from and provides data (e.g., generated IPR(s)) to devices external to the user interface device 120, i.e., the server 100. For example, the communication interface 132 may include a port or connection for receiving a wired connection (for example, an Ethernet cable, fiber optic cable, a telephone cable, or the like), a wireless transceiver, or a combination thereof.

The camera 134 includes an image sensor that generates and outputs image data of a subject. In some examples, the camera 134 includes a semiconductor charge-coupled device (CCD) image sensor, a complementary metal-oxide-semiconductor (CMOS) image sensor, or other suitable image sensor. The electronic processor 122 receives the image data of the subject that is output by the camera 134.

The presence-sensitive display 136 includes a display screen with an array of pixels that generate and output images. In some examples, the display screen is one of a liquid crystal display (LCD) screen, a light-emitting diode (LED) and liquid crystal display (LCD) screen, a quantum dot light-emitting diode (QLED) display screen, an interferometric modulator display (IMOD) screen, a micro light-emitting diode display screen (mLED), a virtual retinal display screen, or other suitable display screen. The presence-sensitive display 136 also includes circuitry that is configured to detect the presence of the user. In some examples, the circuitry is a resistive or capacitive panel that detects the presence of an object (e.g., a user's finger).

It should be understood that, in some embodiments, the server 100 may include fewer or additional components in configurations different from that illustrated in FIG. 1. Also, the server 100 may perform additional functionality than the functionality described herein. In addition, some of the functionality of the user interface device 120 (for example, the IPR generation) may be incorporated into other servers (e.g., incorporated into the server 100). Likewise, some of the functionality of the server 100 may be incorporated into the user interface device 120 (for example, the user identification).

To summarize IPR data, the user interface device 120 collects IPR data for each transaction at a mobile application or at a web page. From the raw IPR data, the server 100 may parse out a set of meaningful biometric features that differentiates same users from different users.

In some examples, a passive biometric identification algorithm included in the authorized fraud detection and mitigation program 106 compares biometric feature values (from current IPR) to biometric feature values seen in the past (from historical IPRs of a global population), and when the current biometric feature values fall within a “reasonable” range of what is seen in the past for the global population, the server 100 may identify the user to be performing a normal operation (e.g., a normal transfer of funds). The passive biometric identification algorithm is an anomaly detection type of algorithm. Each biometric feature may contribute a different weight to the overall model prediction, where a biometric feature with higher predictability power would have a higher weight.

To return the “authorized fraud” detection, the server 100 may determine whether a biometric score indicates, in some examples, hesitancy or uncertainty in an operation. To return the “normal operation” detection, the server 100 may determine whether a biometric score indicates no hesitancy or uncertainty in the operation.

Additionally, in other examples, a passive behavioral identification algorithm may be included in the authorized fraud detection and mitigation program 106. Instead of the passive biometric identification algorithm that compares a current IPR to historical IPRs of a global population, the passive behavioral identification algorithm may look beyond IPR data to non-IPR information, e.g., behaviors at a broader population level. In one example, the passive behavioral identification algorithm may establish that fraud is likely to occur if the user takes more than fifteen seconds or sixty seconds to fill in a page. In another example, the passive behavioral identification algorithm may establish that fraud is likely to occur if the transaction value is $500+/−$50. In yet another example, the passive behavioral identification algorithm may establish that fraud is likely to occur if the transaction occurs at 8 μm or other particular time. Additionally, in another example, the passive behavioral identification algorithm may establish that certain types of hesitation (e.g., mouse doodling) may be present with fraud. The passive behavioral identification algorithm is less about the biometric patterns of a particular user and more about the behavioral patterns of “authorized fraud.”

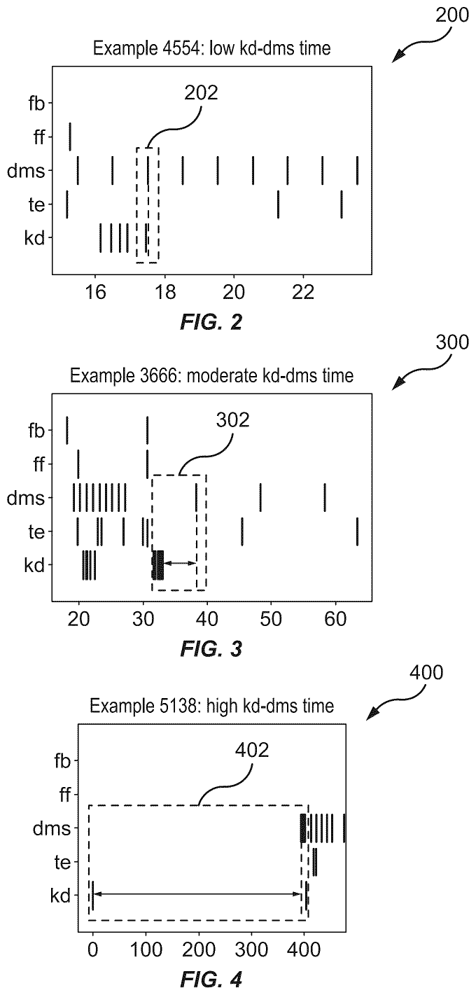

FIGS. 2-4 are charts illustrating example IPRs 200-400 with different IPR events 202, 302, and 402, in accordance with various aspects of the present disclosure. In FIGS. 2-4, the example IPRs 200-400 illustrate five different event types for a single account. The five different event types include 1) field blur (fb), 2) form focus (ff), 3) device motion (dms), 4) touch event (te) and 5) key down (kd). While FIGS. 2-4 illustrate the use of five different event types, more or less than five different event types may also be used, and five different event types are used herein for ease of understanding.

The field blur (fb) is an event that occurs on closing input text elements. The form focus (ff) is an event that occurs on opening input text elements. The device motion (dms) is an event sampling when a user moves the user interface device. The touch event (te) is an event that occurs from an event listener that listens to all views on a presence sensitive display. The keydown (kd) event is from a change in a text character count.

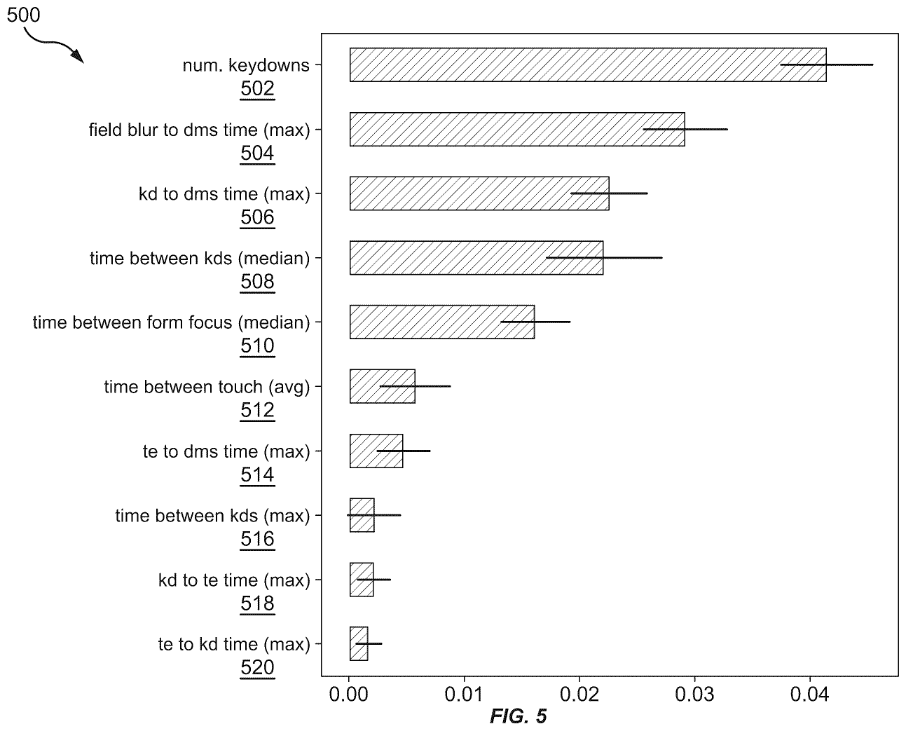

In FIG. 2, the IPR 200 is an example of a low kd-dms time 202. As illustrated on the X-axis, the low kd-dms time 202 is less than two seconds. In FIG. 3, the IPR 300 is an example of a moderate kd-dms time 302. As illustrated on the X-axis, the moderate kd-dms time 302 is greater than two seconds and less than ten seconds. In FIG. 4, the IPR 400 is an example of a high kd-dms time 402. As illustrated on the X-axis, the high kd-dms time 402 is greater than ten seconds and less than 400 seconds.

The IPRs 200-400 may be represented as different IPR strings. An example Android IPR string is “non-fraud 5b2apHc=(first row, second column).” An example Android Web IPR string is counts of the above Android IPR “[(‘ac’, 182), (‘lac’, 149), (‘gy’, 55), (‘or’, 51), (‘mms’, 10), (‘te’, 5), (‘kd’, 5), (‘ku’, 5), (‘mm’, 2), (‘mc’, 2), (‘ncip’, 1), (‘st’, 1), (‘kk’, 1), (‘ff’, 1), (‘fb’, 1)].”

The time information is the last piece of information in each event grouping. In your example it would be the number (182, 149, 55).

A small sample: ncip,0,65e0e795,2,1;st,0,sid,0,,0;ff,0,ndiprinput1;kd,1a8,0;kd,c,1; ku,58,1;kd,19,1;ku,7,0;kd,67,1;kd,b,2;ku,64,2;ku,17,1;ku,b,1;kd,2ba,0,5;kd,2d,1,5;kd,66,2;ku,17 2,0;ku,c,1;fb,15,ndiprinput1;mm,177,109,lab,requestJson;mms,3ea,0,a,27 51a,bc9 2918,d96, da2,-16038,d124,-2f2a;mms,3e7,3e8,a,NOP;mms,3e8,3e8,a,NOP;mms,3e7,3e7,a,NOP;mms, 3ea,3ea,a,NOP;mms,3e7,3e7,a,NOP;mms,3e8,3e8,a,NOP;mms,3e8,3e8,a,NOP.

The above IPR charts give an idea of how the IPR data looks, but it is not easy to manually come up with distinguishing characteristics for fraud/non-fraud based on the IPR data. To determine distinguishing characteristics of “authorized fraud,” a machine learning (ML) classifier is trained to distinguish fraud and non-fraud requests for the purposes of feature exploration and not as a scam detector. The techniques, devices, systems, methods, and non-transitory computer-readable media as described herein may be applicable to other fraud and non-fraud requests, e.g., a money transfer request.

Below, in FIG. 5, are results based on basic IPR features only using the current profile only (no historical profiles). Note, the dms features are not using motion magnitude, only temporal information.

FIG. 5 is a chart illustrating IPR feature importance 500, in accordance with various aspects of the present disclosure. In FIG. 5, the IPR feature importance 500 includes a number of key downs feature 502, a field blur to dms time (max) feature 504, a kd to dms time (max) feature 506, a time between kds (median) feature 508, a time between form focus (median) feature 510, a time between touch (avg) feature 512, a te to dms time (max) feature 514, a time between kds (max) feature 516, a kd to te time (max) feature 518, and a te to kd time (max) feature 520.

The kd to dms time (max) feature 506 is the maximum time between consecutive keydown and device motion events. The calculation of the kd to dms time (max) feature 506 is illustrated above in IPRs 200-400.

The number of key downs feature 502 is the number of text changes in text field. The field blur to dms time (max) feature 504 the maximum time between closing an input text element to a device motion event. The time between kds (median) feature 508 is a median of the time between keydown events. The time between form focus (median) feature 510 is a median of the time between opening input text elements. The time between touch (avg) feature 512 is an average of the time between touch events. The te to dms time (max) feature 514 is the maximum time between a touch event and a device motion event. The time between kds (max) feature 516 is the maximum time between keydown events. The kd to te time (max) feature 518 is the maximum time between a keydown event and a touch event. The te to kd time (max) feature 520 is the maximum time between a touch event and key down event.

As illustrated in FIG. 5, the IPR feature importance 500 shows the number of key downs feature 502 having an importance of 0.04. The IPR feature importance 500 shows the field blur to dms time (max) feature 504 having an importance of approximately 0.03. The IPR feature importance 500 shows the kd to dms time (max) feature 506 having an importance of approximately 0.02. The IPR feature importance 500 shows the time between kds (median) feature 508 having an importance of approximately 0.02. The IPR feature importance 500 shows the time between form focus (median) feature 510 having an importance of approximately 0.015. The IPR feature importance 500 shows the time between touch (avg) feature 512 having an importance of 0.01. The IPR feature importance 500 shows the te to dms time (max) feature 514 having an importance of 0.007. The IPR feature importance 500 shows the time between kds (max) feature 516 having an importance of 0.004. The IPR feature importance 500 shows the kd to te time (max) feature 518 having an importance of 0.004. The IPR feature importance 500 also shows the te to kd time (max) feature 520 having an importance of 0.001.

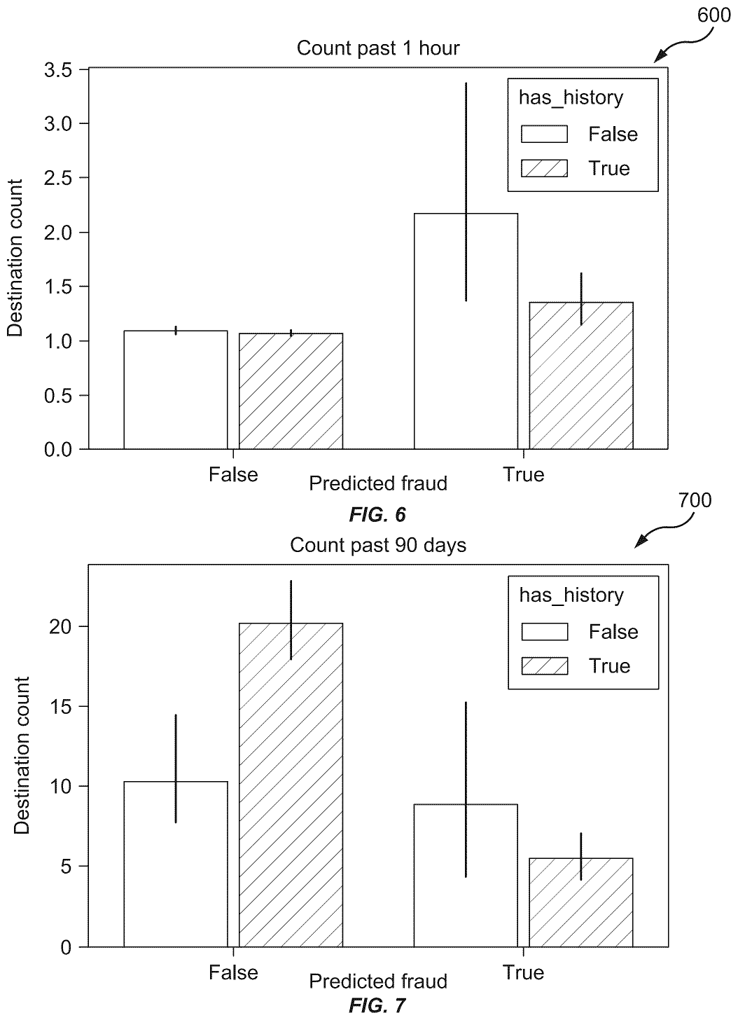

FIGS. 6 and 7 are charts illustrating example non-IPR information 600 and 700, in accordance with various aspects of the present disclosure. In FIG. 6, the non-IPR information 600 is the number of transactions the destination (e.g., an account identified by phone number, email address, etc.) received in the previous one hour prior to the transaction being scored. In the example non-IPR information 600, for non-fraud transactions, the average count is one while larger values are seen for fraudulent transactions (though the variability is high).

In FIG. 7, the non-IPR information 700 is the number of transactions the destination (e.g., an account identified by phone number, email address, etc.) received in the previous ninety days prior to the transaction being scored. In the example non-IPR information 700, for non-fraud transactions, the average count is twenty while lower values are seen for fraudulent transactions.

In view of FIGS. 6 and 7, a pattern exists between the non-IPR information 600 and the non-IPR information 700. When looking at account history within the last hour, a higher number of transactions indicates a higher likelihood the destination account is receiving funds from “authorized fraud.” Comparatively, when looking at account history within the last ninety days, a higher number of transactions indicates a higher likelihood the destination account is not receiving funds from “authorized fraud.” This pattern may be used to provide additional fraud signals beyond the signals obtained from analyzing the IPR data. The additional fraud signals may include “[i]f account has limited history and transfer amount is high, then add ‘new send-funds activity: suspicious transfer amount’ insight.” The additional fraud signals may also include “[i]f account has limited history, but destination account received large number of transactions in the past hour, then add ‘new send-funds activity: recipient high volume’ insight.”

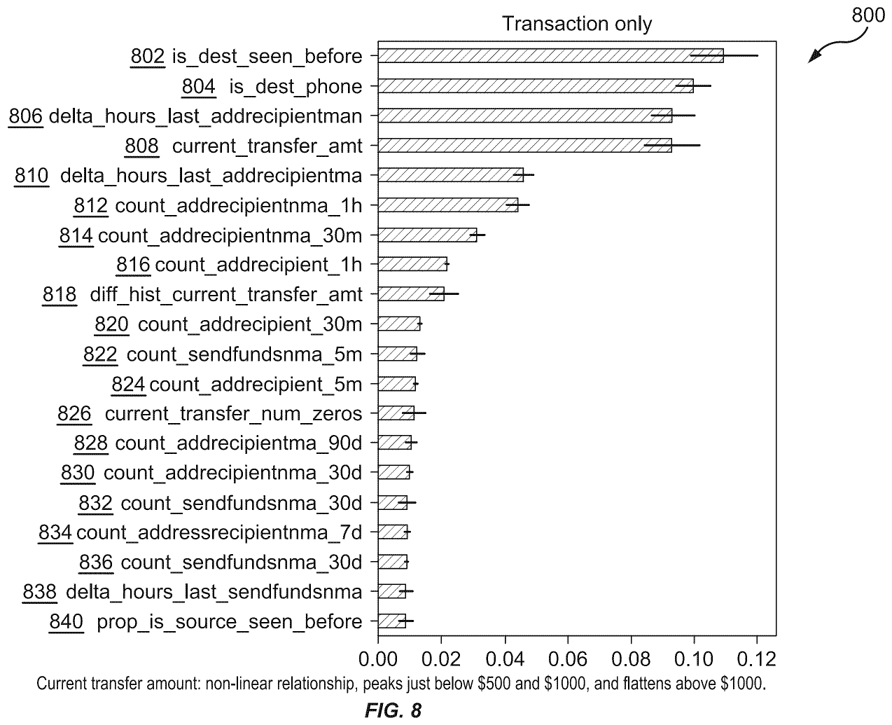

FIG. 8 is a chart illustrating transaction only feature importance 800, in accordance with various aspects of the present disclosure. In FIG. 8, the transaction only feature importance 800 includes a number of features: the transaction only feature importance 800 includes a number of features: is_dest_seen_before feature 802, is_dest_phone feature 804, delta_hours_last_addrecipientnma feature 806, current_transfer_amt feature 808, delta_hours_last_addrecipient feature 810, count_addrecipientnma_1h feature 812, count_addrecipientnma_30m feature 814, count_addrecipient_1h feature 816, diff_hist_current_transfer_amt feature 818, count_addrecipient_30m feature 820, count_sendfundsnma_5m feature 822, count_addrecipient_5m feature 824, current_transfer_num_zeros feature 826, count_addrecipientmma_90d feature 828, count_addrecipientmma_30d feature 830, count_sendfundsnma_30d feature 832, count_addrecipientmma_7d feature 834, count_sendfunds_30d feature 836, delta_hours_last_sendfundsnma feature 838, and prop_is_source_seen_before feature 840.

The is_dest_seen_before feature 802 is an indication of whether the destination address has been targeted in the past. The is_dest_phone feature 804 is an indication of whether the destination address is a phone number. The delta_hours_last_addrecipientnma feature 806 is an indication of a number of hours since a recipient has been added to a native mobile application (nma). The current_transfer_amt feature 808 is an indication of the current amount being transferred to the destination account. In some examples, the current amount being transferred (or “current transfer amount”) has a non-linear relationship, where the current amount peaks just below $500 and $1000, and flattens above $1000.

The delta_hours_last_addrecipient feature 810 is an indication of a number of hours since a recipient has been added to an application (note the lack of “nma” indicates a web-based version of the application). The count_addrecipientnma_1h feature 812 is an indication of a count of added recipients to an application in the last hour. The count_addrecipientnma_30m feature 814 is an indication of a count of added recipients to an application in the last thirty minutes. The count_addrecipient_1h feature 816 is an indication of a count of added recipients to an application in the last hour. The diff_hist_current_transfer_amt feature 818 is an indication of a difference in a historical versus current transfer amount. The count_addrecipient_30m feature 820 is an indication of a count of added recipients to an application in the last thirty minutes.

The count_sendfundsnma_5m feature 822 is an indication of a count of funds sent to recipients in the last five minutes. The count_addrecipient_5m feature 824 is an indication of a count of added recipients to an application in the last five minutes. The current_transfer_num_zeros feature 826 is an indication of a number of zeros in the current transfer. The count_addrecipientmma_90d feature 828 is an indication of a count of added recipients to an application in the last ninety days. The count_addrecipientmma_30d feature 830 is an indication of a count of added recipients to an application in the last thirty days. The count_sendfundsnma_30d feature 832 is an indication of a count of funds sent to recipients in the last thirty days. The count_addrecipientnma_7d feature 834 is an indication of a count of added recipients to an application in the last seven days. The count_sendfunds_30d feature 836 is an indication of a count of funds sent in the last thirty days. The delta_hours_last_sendfundsnma feature 838 is an indication of a number of hours since a recipient has last sent funds. The prop_is_source_seen_before 840 is an indication of the proportion of historical transactions when a familiar source bank account (seen before) was used to fund the transfer.

As illustrated in FIG. 8, the is_dest_seen_before feature 802 has an importance of 0.11. The is_dest_phone feature 804 has an importance of 0.10. The delta_hours_last_addrecipientnma feature 806 has an importance of 0.09. The current_transfer_amt feature 808 has an importance of 0.09. The delta_hours_last_addrecipientfeature 810 has an importance of 0.05. The count_addrecipientnma_1h feature 812 has an importance of 0.05. The count_addrecipientnma_30m feature 814 has an importance of 0.04. The count_addrecipient_1h feature 816 has an importance of 0.02. The diff_hist_current_transfer_amt feature 818 has an importance of 0.02. The count_addrecipient_30m feature 820 has an importance of 0.0175.

As illustrated in FIG. 8, the count_sendfundsnma_5m feature 822 has an importance of 0.015. The count_addrecipient_5m feature 824 has an importance of 0.015. The current_transfer_num_zeros feature 826 has an importance of 0.015. The count_addrecipientmma_90d feature 828 has an importance of 0.015. The count_addrecipientmma_30d feature 830 has an importance of 0.01. The count_sendfundsnma_30d feature 832 has an importance of 0.01. The count_addrecipientnma_7d feature 834 has an importance of 0.01. The count_sendfunds_30d feature 836 has an importance of 0.01. The delta_hours_last_sendfundsnma feature 838 has an importance of 0.01. The prop_is_source_seen_before 840 has an importance of 0.01.

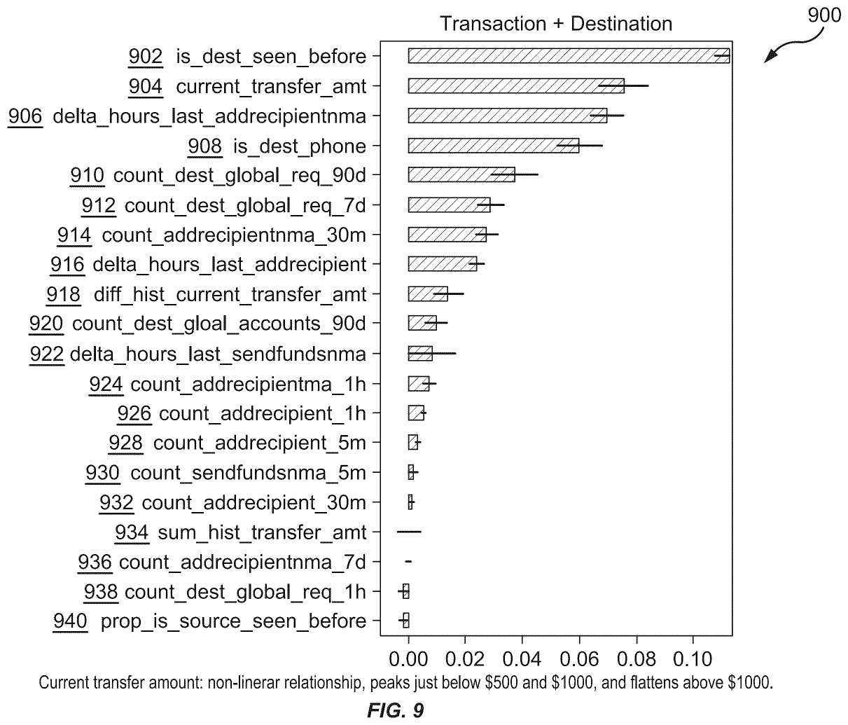

FIG. 9 is a chart illustrating transaction and destination feature importance 900, in accordance with various aspects of the present disclosure. In FIG. 9, the transaction and destination feature importance 900 includes is_dest_seen_before feature 902, current_transfer_amt feature 904, delta_hours_last_addrecipientnma feature 906, is_dest_phone feature 908, count_dest_global_req_90d feature 910, count_dest_global_req_7d feature 912, count_addrecipientnma_30m feature 914, delta_hours_last_addrecipient feature 916, diff_hist_current_transfer_amt feature 918, count_dest_global_accounts_90d feature 920, delta_hours_last_sendfundsnma feature 922, count_addrecipientnma_1h feature 924, count_addrecipient_1h feature 926, count_addrecipient_5m feature 928, count_sendfundsnma_5m feature 930, count_addrecipient_30m feature 932, sum_hist_transfer_amt feature 934, count_addrecipientnma_7d feature 936, count_dest_global_req_1h feature 938, and prop_is_source_seen_before 940.

Some of the features in FIG. 9 are similar to the features of FIG. 8. Consequently, description of these similar features are not repeated herein. Unlike the transaction only feature importance 800, the transaction and destination feature importance 900 includes count_dest_global_req_90d feature 910, count_destglobal_req_7d feature 912, count_dest_global_accounts_90d feature 920, sum_hist_transfer_amt feature 934, and count_dest_global_req_1h feature 938. The term “global” is referring to a computation across all traffic for a given bank and given time period.

The count_dest_global_req_90d feature 910 is an indication of a count of a destination's total number of global requests in the last ninety days. The count_dest_global_req_7d feature 912 is an indication of a count of a destination's global requests in the last seven days. The count_dest_global_accounts_90d feature 920 is an indication of a count of unique accounts (senders) for that destination in the last ninety days. The sum_hist_transfer_amt feature 934 is an indication of a sum of a historical transfer amount for the destination. The count_dest_global_req_1h feature 938 is an indication of a count of a destination's global requests in the last hour.

As illustrated in FIG. 9, the is_dest_seen_before feature 902 has an importance of 0.11. The current_transfer_amt feature 904 has an importance of 0.07. The delta_hours_last_addrecipientnma feature 906 has an importance of 0.06. The is_dest_phone feature 908 has an importance of 0.05. The count_dest_global_req_90d feature 910 has an importance of 0.05. The count_dest_global_req_7d feature 912 has an importance of 0.03. The count_addrecipientnma_30m feature 914 has an importance of 0.03. The delta_hours_last_addrecipient feature 916 has an importance of 0.03. The diff_hist_current_transfer_amt feature 918 has an importance of 0.02. The count_dest_global_accounts_90d feature 920 has an importance of 0.01. The delta_hours_last_sendfundsnma feature 922 has an importance of 0.01. The count_addrecipientnma_1h feature 924 has an importance of 0.01. The count_addrecipient_1h feature 926 has an importance of 0.005. The count_addrecipient_5m feature 928 has an importance of 0.003. The count_sendfundsnma_5m feature 930 has an importance of 0.002. The count_addrecipient_30m feature 932 has an importance of 0.001. The sum_hist_transfer_amt feature 934 has an importance of 0.0005. The count_addrecipientnma_7d feature 936 has an importance of 0.0001. The count_dest_global_req_1h feature 938 has an importance of 0.002. The prop_is_source_seen_before 940 has an importance of 0.002.

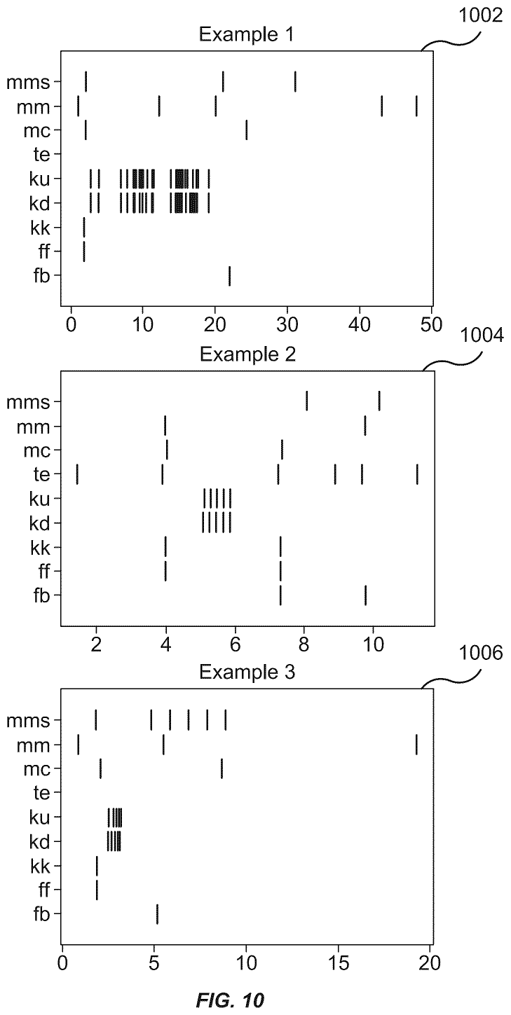

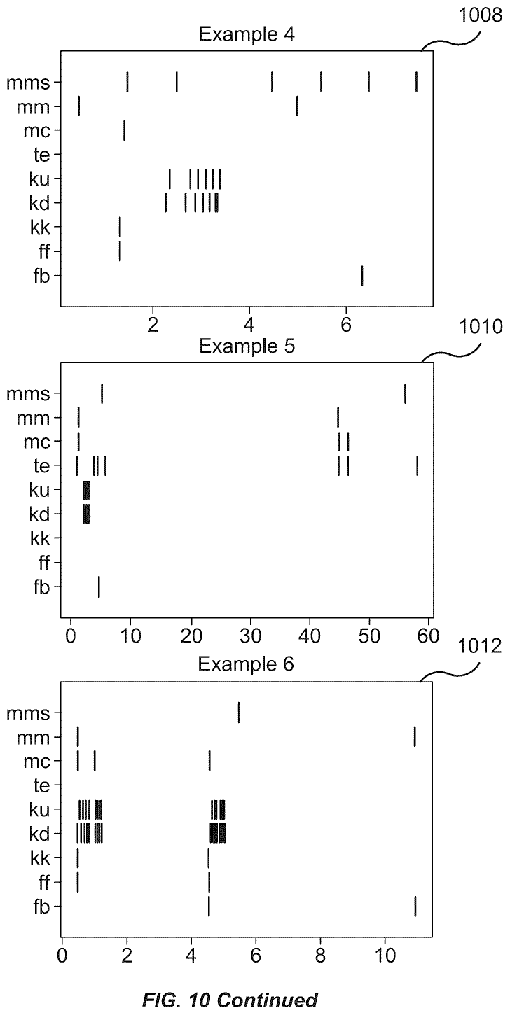

FIG. 10 is a chart illustrating example IPRs with different interaction based and time-based IPR events, in accordance with various aspects of the present disclosure. In FIG. 10, the example IPRs 1002-1012 illustrate nine different event types for a single account. The Y-axis has nine different event types including 1) mouse movement sample (mms), 2) mouse movement (mm), 3) mouse click (me), 4) touch event (te), 5) key up (ku), 6) key down (kd), 7) character count of a given field at a given time (kk), 8) form focus (ff), and 9) field blur (fb). The X-axis is time in seconds. While FIG. 10 illustrates the use of nine different event types, more or less than nine different event types may also be used (e.g., as shown in FIGS. 2-4).

The mouse movement sample (mms) is from mouse movement data that is cached any time the mouse is moved, and samples of the movement are taken on configurable frequencies. In some examples, parameters of mms may include (delta_last_mms=1102, #time since last mms, num_samples=10, min_velocity=[0.3019, 0.1481], max_velocity=[0.3019, 0.1481], avg_magn_velocity=0.0361, total_distance=0.0747, min_acc=−3.8011, max_acc=1.7444, avg_acc=−0.1557).

The mouse movement (mm) is data sent at a configurable frequency, providing mouse position, in pixels, relative to the top left of the document area. In some examples, parameters of mm may include (x=165, y=620, element=‘amount’).

The mouse click (me) has similar parameters to a touch event (te) in mobile, where data is sent whenever a mouse click event occurs on a page. In some examples, the parameters of mc may include (x=103, y=712, element=‘amount’).

In the case of the touch event (te), data is sent whenever a touchstart event occurs on the page. In some examples, the parameters of te may include (x=103, y=713, element=‘amount’).

The key up (ku) event is a specific action of a user releasing a key, either on a physical or ‘touch’ based keyboard. The keydown (kd) event is a specific action of a user depressing a key, either on a physical or ‘touch’ based keyboard. A keydown event is typically followed by a quick keyup event. However, when a key is held to produce “aaaaaaaaaa,” then in the IPR there would be a keydown event, some time delay, and a keyup event.

The form focus (ff) is an event that occurs on opening input text elements. The field blur (fb) is an event that occurs on closing input text elements.

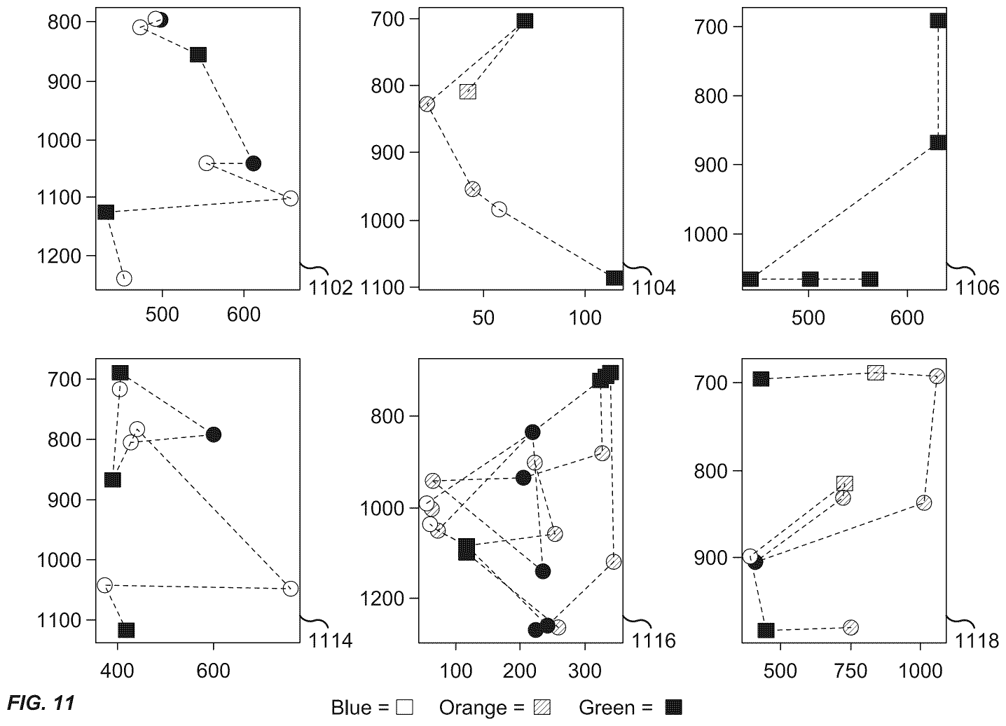

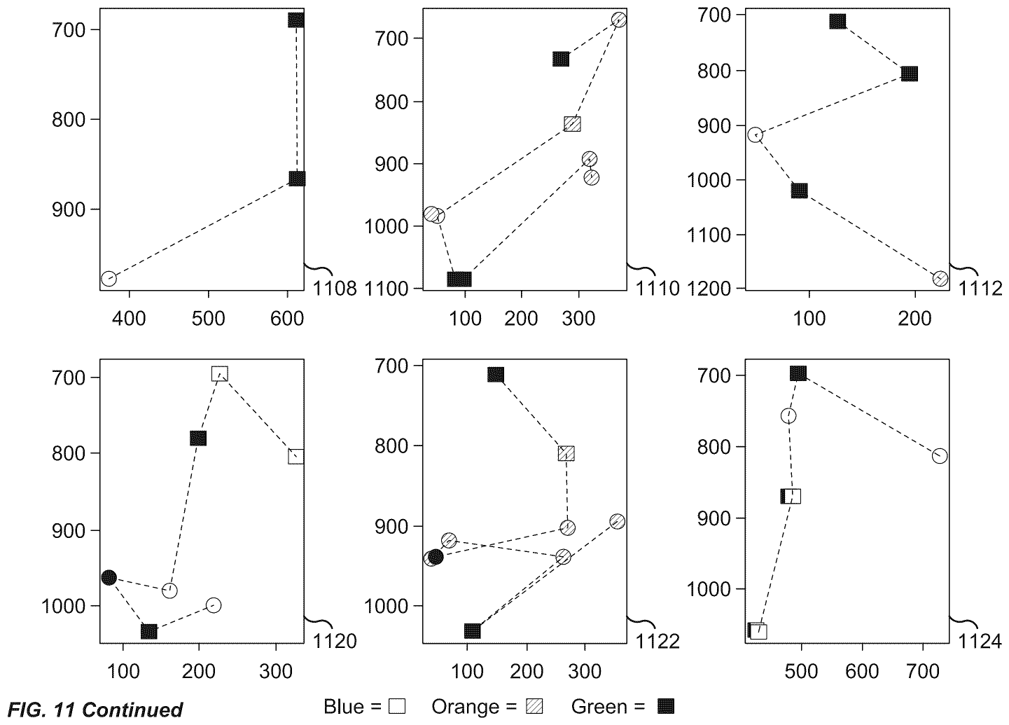

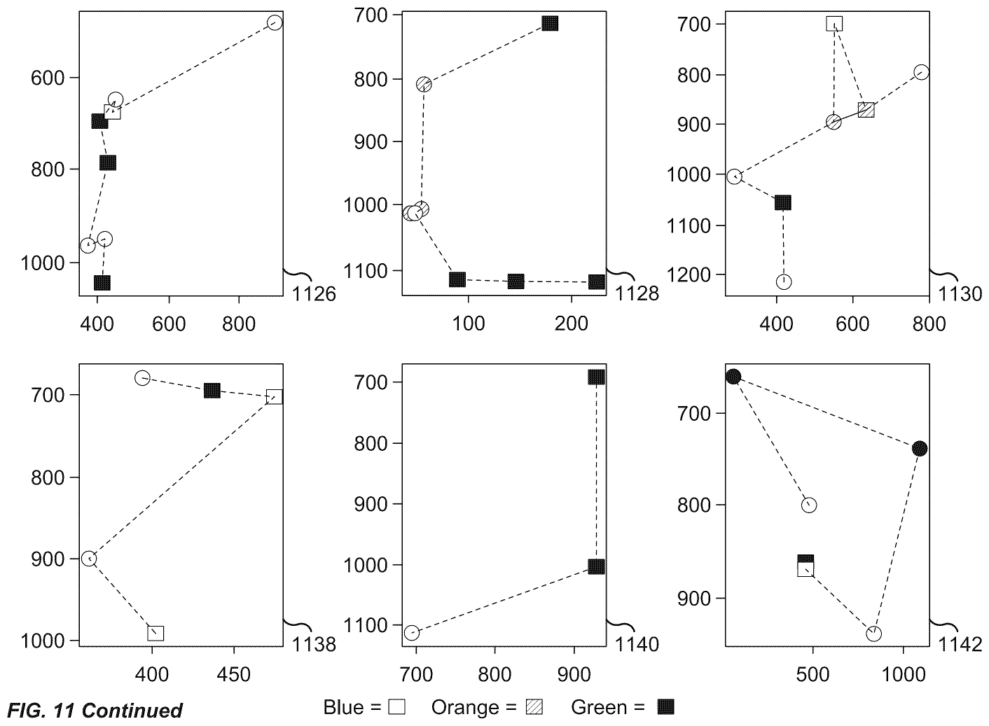

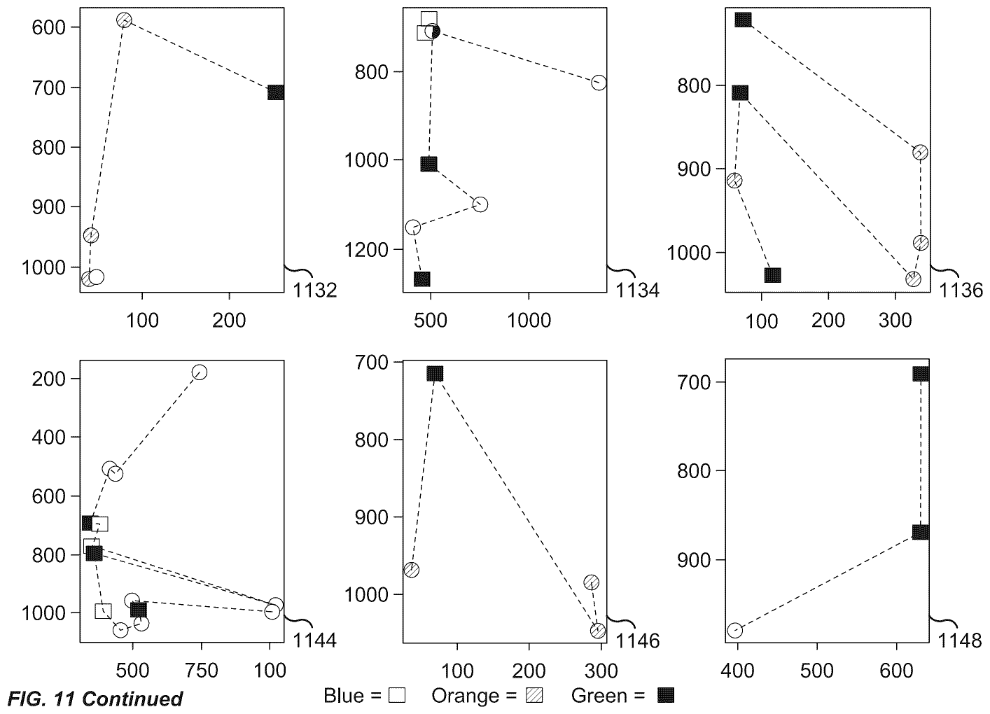

FIG. 11 is a chart illustrating example IPRs 1102-1148 with different mouse interaction IPR events, in accordance with various aspects of the present disclosure. In FIG. 11, the example IPRs 1102-1148 illustrate twenty-four different examples of non-fraud mouse interactions. The X-axis is a number of horizontal pixels, and the Y-axis is a number of vertical pixels.

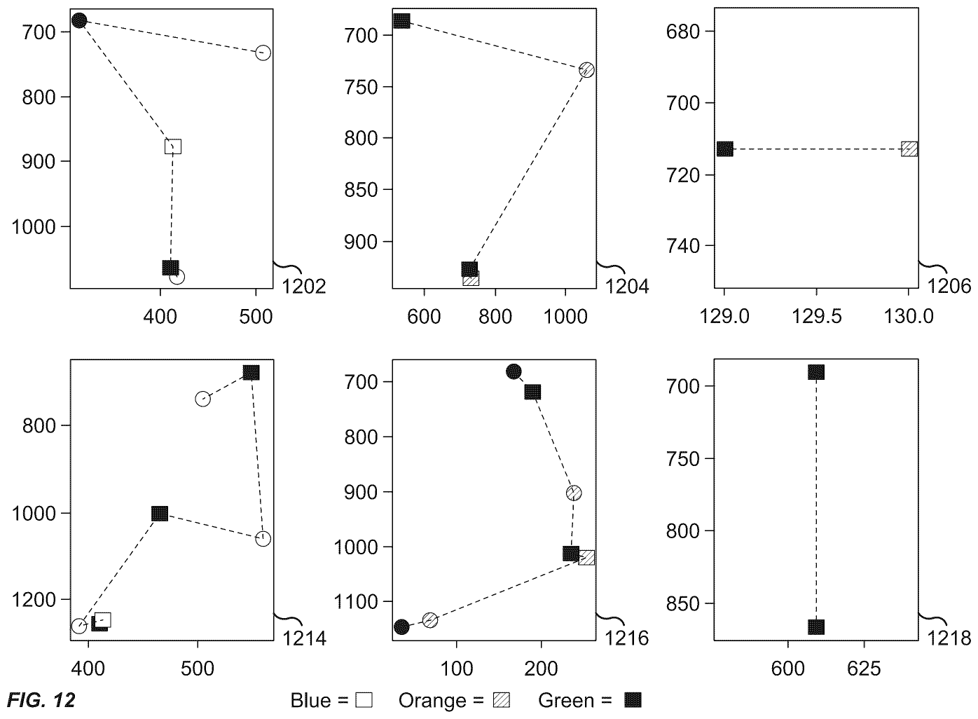

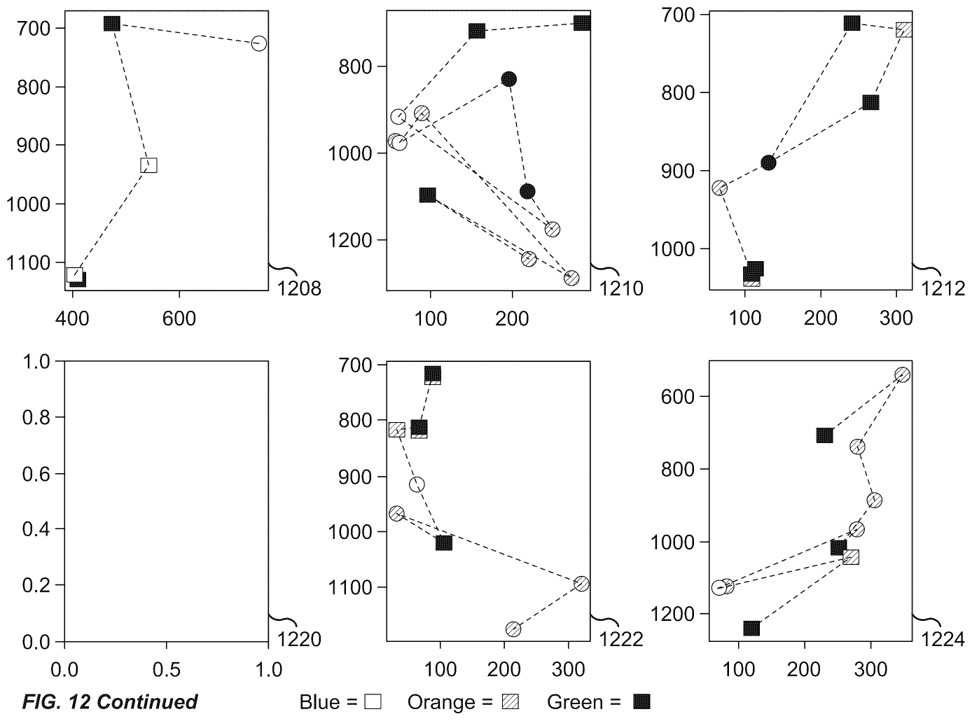

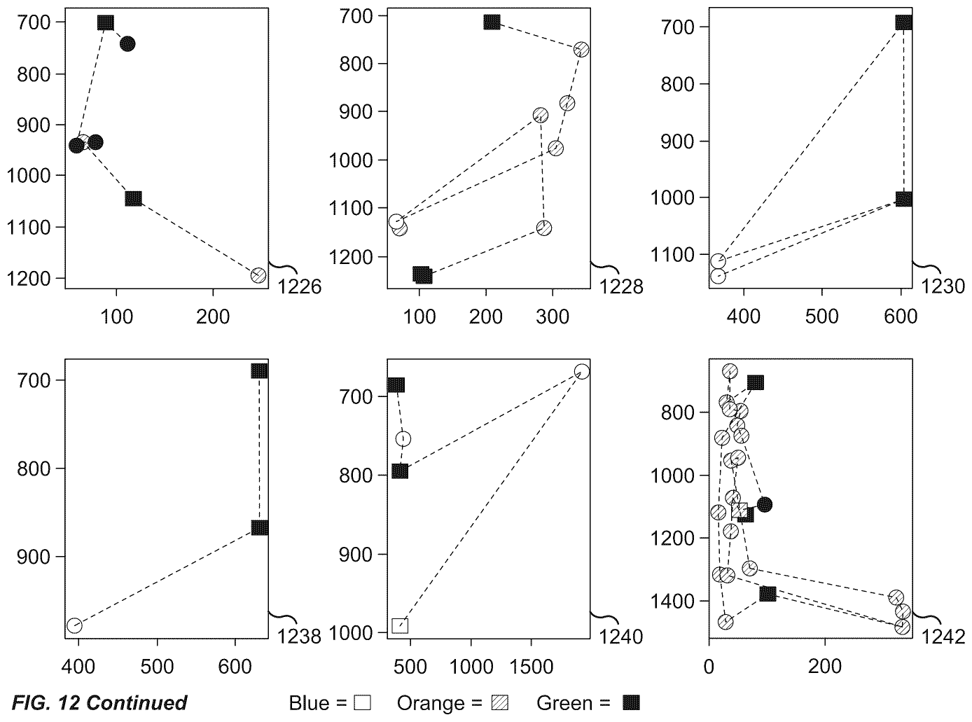

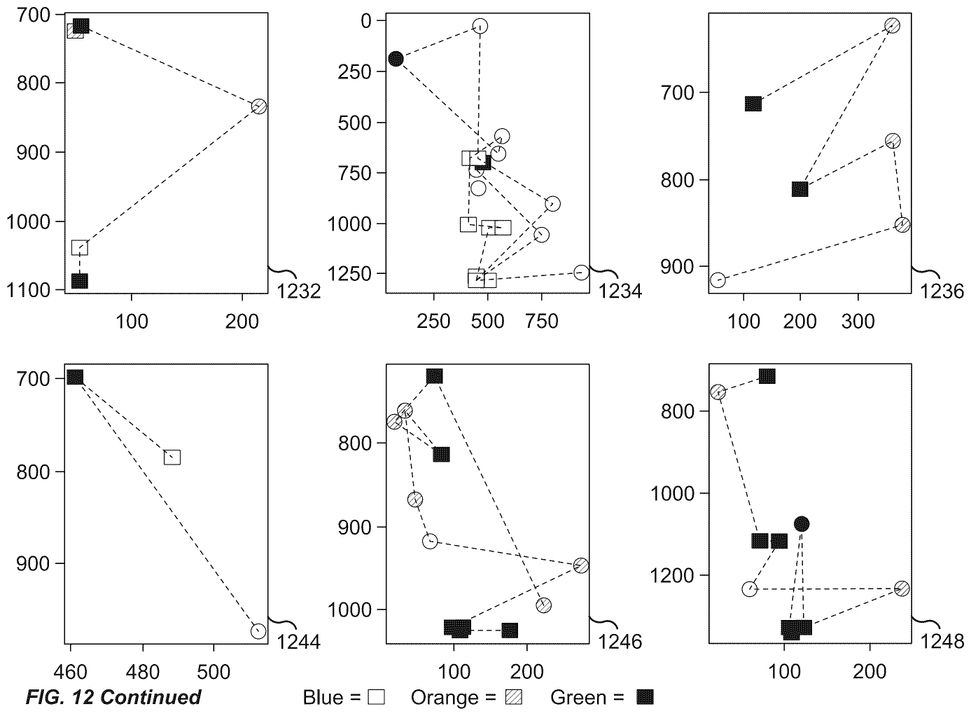

FIG. 12 is a chart illustrating example IPRs 1202-1248 with different mouse interaction IPR events, in accordance with various aspects of the present disclosure. In FIG. 12, the example IPRs 1202-1248 illustrate twenty-four different examples of fraudulent mouse interactions. The X-axis is a number of horizontal pixels, and the Y-axis is a number of vertical pixels.

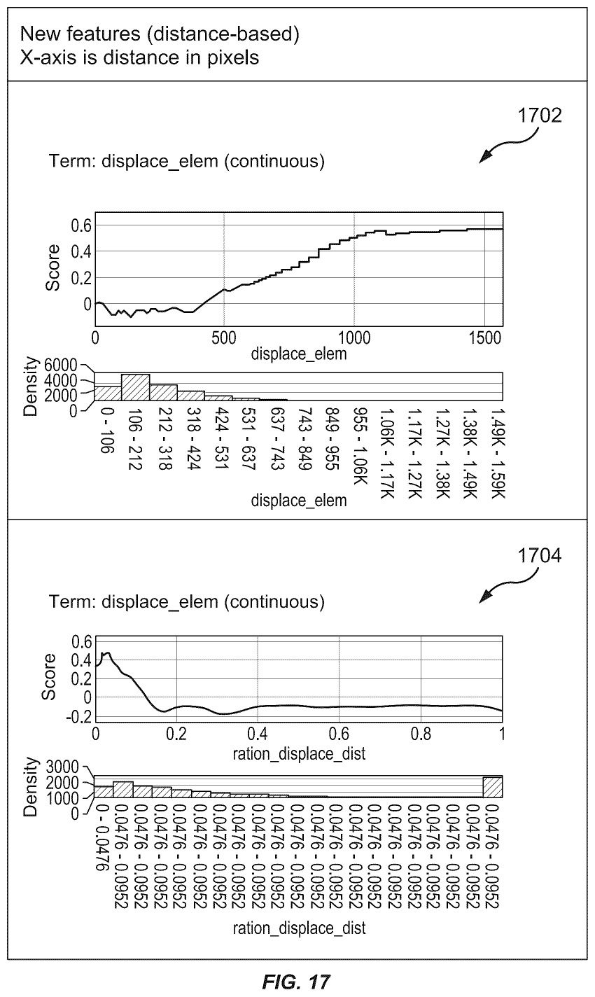

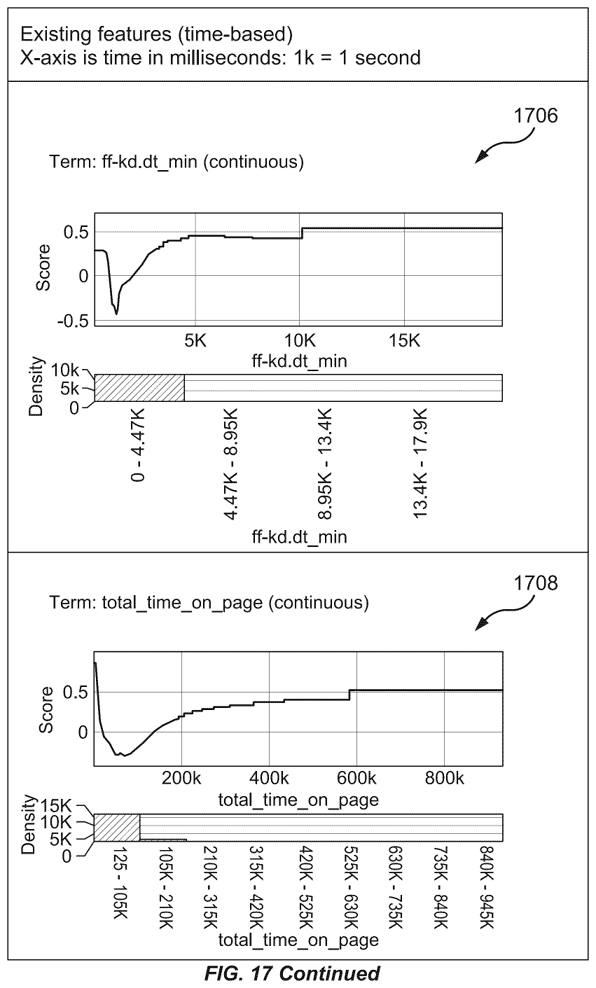

Several interaction-based features may be generated from the IPRs of FIGS. 11 and 17 including 1) distance, 2) displacement, 3) ration of displacement/distance, and 4) features 1-3 but only including events where a user interacts with an element on a page.

Distance is the total distance “travelled” by accumulating all distances between starting and ending points. Displacement is the distance between starting point and ending point only, e.g., when you make a complete circle with the mouse and return to starting point, you will have small displacement, and a potentially large distance.

Ratio displacement/distance is ratio of displacement to distance. With mouse doodling, a low ratio near zero is expected, i.e., small displacements and large distances.

However, there are some limitations with respect to the above features. One limitation is that the distance and displacement features are computed in pixels, and consequently, depend on screen/page size. Therefore, distance and displacement features may be normalized by screen resolution. The ratio feature does not have this limitation because it is dimensionless.

Another limitation is that the measured distances will also depend on page layout. Therefore, page layouts (or certain elements of page layouts) may also be normalized.

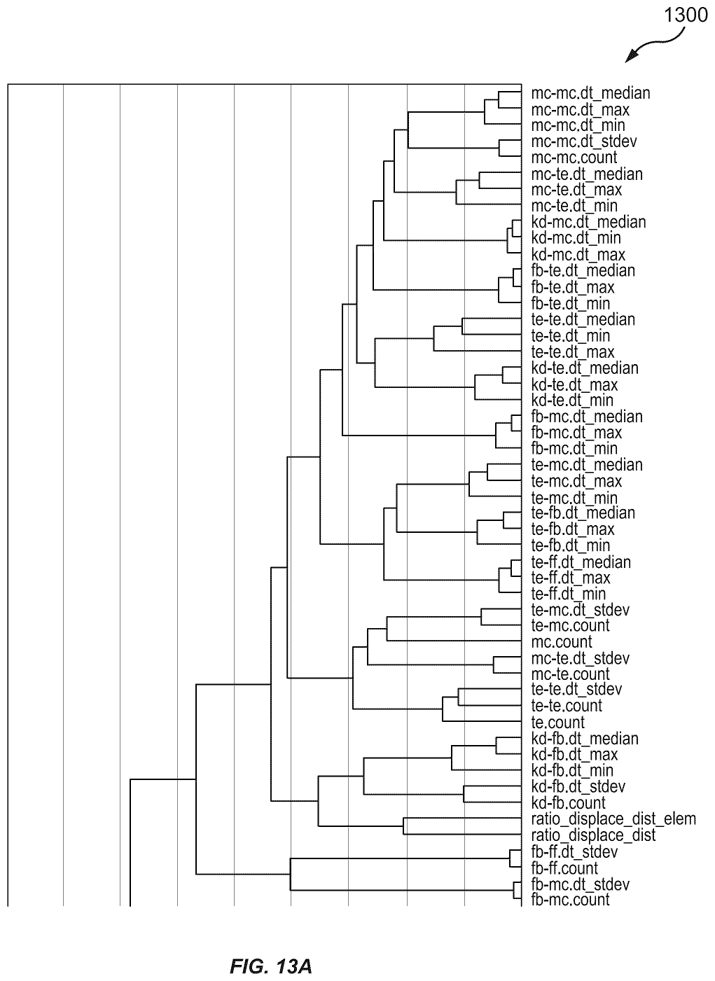

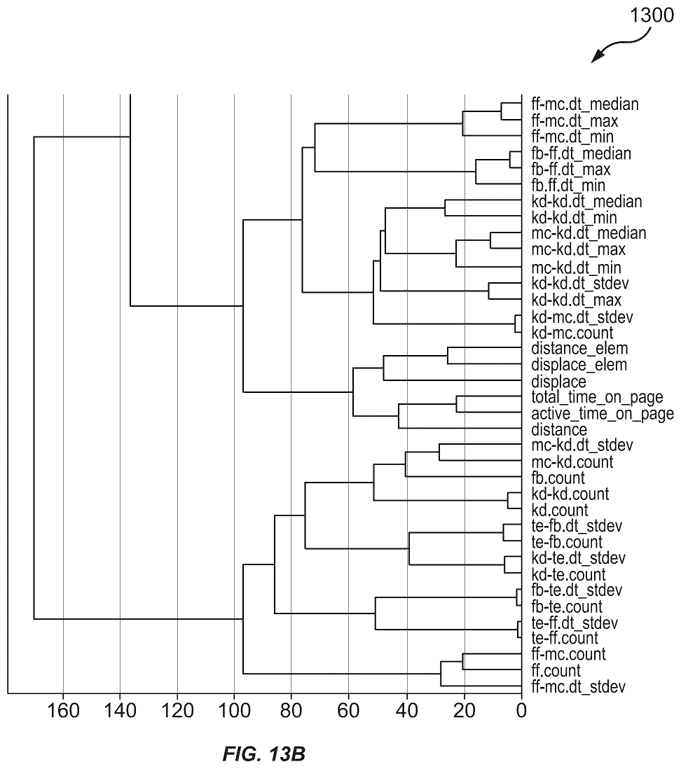

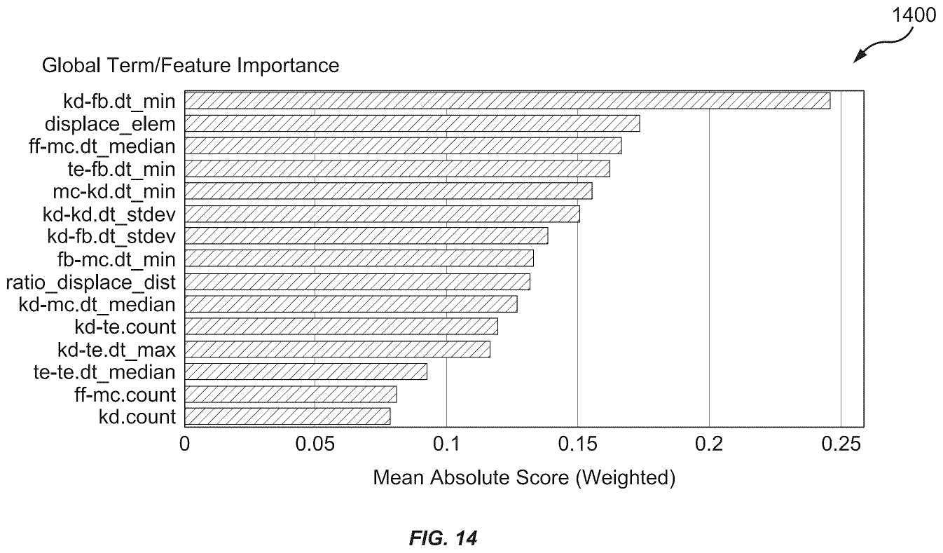

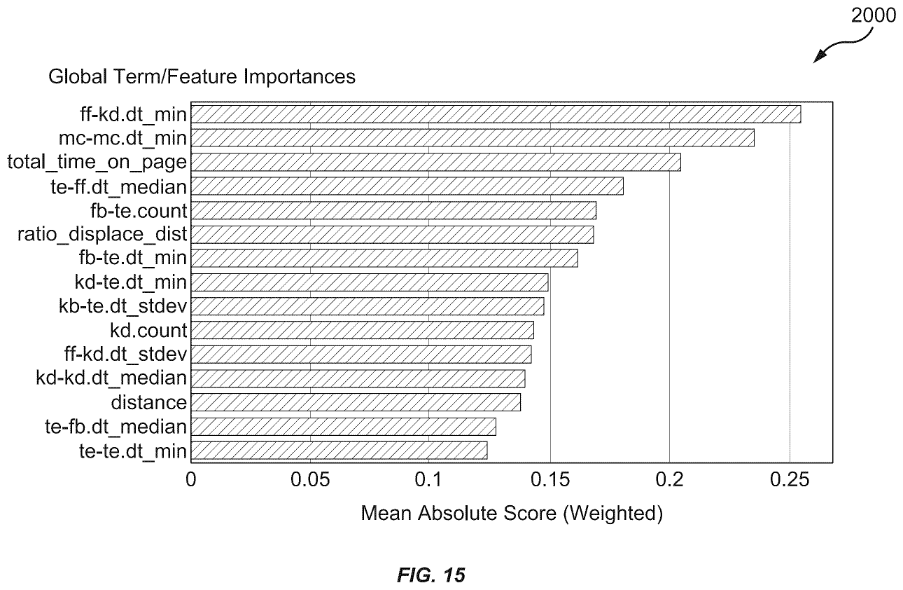

A large number of IPR features may be generated from the mouse/touch events and the time-based events, many of which are correlated. FIGS. 13A and 13B are diagrams illustrating a hierarchical clustering 1300 to group an example of the large number of features together, in accordance with various aspects of the present disclosure. One feature may then be “cut” from the hierarchical clustering by selecting one feature from each branch. This “cut” reduces feature correlation. FIG. 14 is a chart illustrating feature importance example 1400 when including IPR features with respect to a first of two different entities, in accordance with various aspects of the present disclosure. FIG. 15 is a chart illustrating feature importance example 1500 when including IPR features with respect to a second of two different entities, in accordance with various aspects of the present disclosure.

The new feature displace_elem (displacement computed on page elements only) ranks second highest for the example 1400. The ratio between distance and displacement is further down the list of the example 1400.

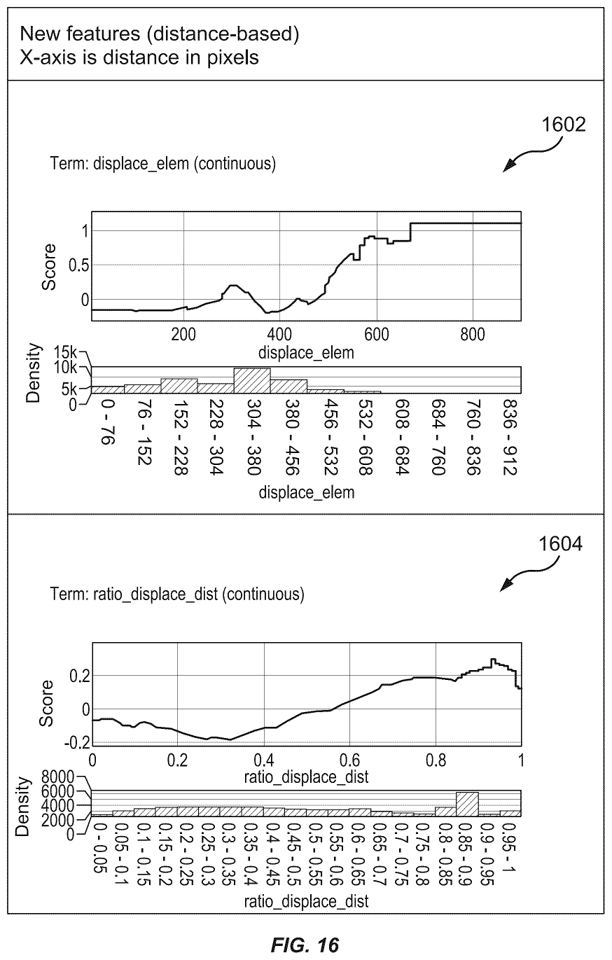

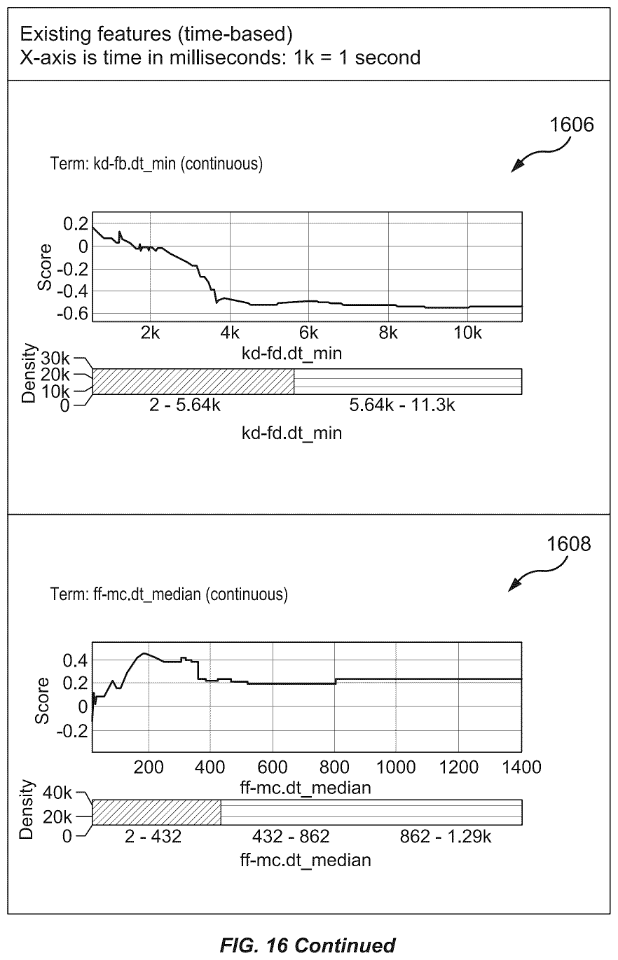

The relationship with outcome variable for new features and some of existing ones may also be examined. FIG. 16 is a diagram illustrating plots 1602-1608 of these new features (distance-based) and existing features (time-based) with respect to the example 1400 of FIG. 14, in accordance with various aspects of the present disclosure. Specifically, FIG. 16 illustrates a first plot 1602 of displace_element (continuous), a second plot 1604 of ratio_distance_dist (continuous), a third plot 1606 of kd-fb.dt_min (continuous), and a fourth plot 1608 of ff-mc.dt_median (continuous). In the plots 1602-1608, the X-axis shows the feature value. The higher score on the Y-axis means a higher fraud risk.

FIG. 17 illustrates plots 1702-1708 of these new features (distance-based) and existing features (time-based) with respect to the example 1500 of FIG. 15, in accordance with various aspects of the present disclosure. Specifically, FIG. 17 illustrates a first plot 1702 of displace_element (continuous), a second plot 1704 of ratio_distance_dist (continuous), a third plot 1706 of ff-kd.dt_min (continuous), and a fourth plot 1708 of total_time_on_page (continuous). In the plots 1702-1708, the X-axis shows the feature value. The higher score on the Y-axis means a higher fraud risk.

For both examples 1400 and 1500, higher displacement (when interacting with elements only) is associated with increased fraud risk. The ratio (distance/displacement) gives inconsistent results, for the example 1500, a low ratio tends to have a higher score. For the example 1400, the ratio is the opposite, but ratio is not a strong signal for the example 1400.

Additionally, in the example 1500, the time on page and ff-kd.dt_min (minimum time between form focus and starting to type) have an interesting behavior. Extreme values are associated with a higher risk of fraud.

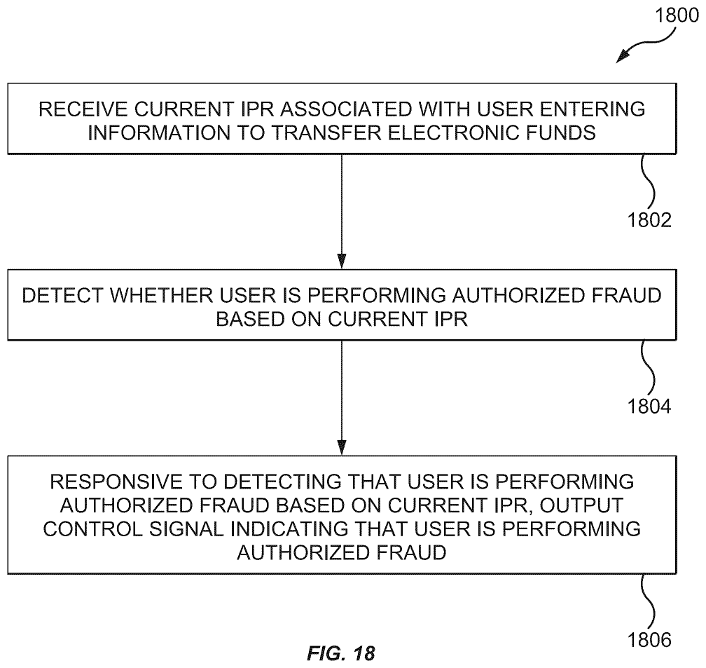

FIG. 18 is a flowchart illustrating a first example method 1800 for detecting authorized fraud, in accordance with various aspects of the present disclosure. FIG. 18 is described with respect to FIG. 1.

The method 1800 includes receiving, with an electronic processor, a current input profile record (IPR) associated with a user entering information to transfer electronic funds (at block 1802). For example, the electronic processor 102 receives a current IPR associated with a current user of the user interface device 120 from the client server 140.

The method 1800 includes detecting, with the electronic processor, whether the user is performing authorized fraud based on the current IPR (at block 1804).

The method 1800 includes responsive to detecting that the user is performing authorized fraud based on the current IPR, outputting, with the electronic processor, a control signal indicating that the user is performing authorized fraud based on the current IPR (at block 1806). In some examples, the control signal causes the client server 140 to approve, hold, or deny the transfer of the electronic funds. In some examples, the control signal is a “score.” The “score” may be a Boolean, a high/medium/low risk signal, or other suitable score signal that may be used as a threshold trigger.

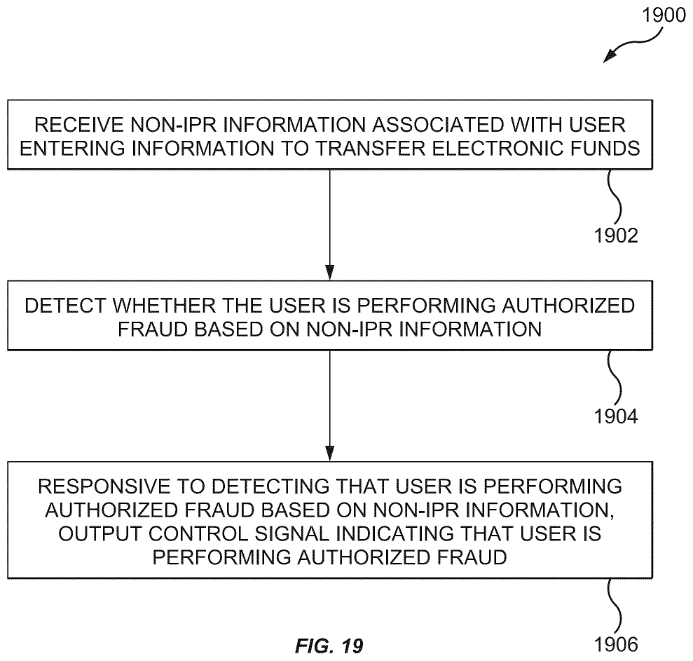

FIG. 19 is a flowchart illustrating a second example method 1900 for detecting authorized fraud, in accordance with various aspects of the present disclosure. FIG. 19 is described with respect to FIG. 1.

The method 1900 includes receiving, with an electronic processor, non-input profile record (IPR) information associated with a user entering information to transfer electronic funds (at block 1902). For example, the electronic processor 102 receives non-IPR information associated with a current user of the user interface device 120 from the client server 140.

The method 1900 includes detecting, with the electronic processor, whether the user is performing authorized fraud based on the non-IPR information (at block 1904).

The method 1900 includes responsive to detecting that the user is performing authorized fraud based on the non-IPR information, outputting, with the electronic processor, a control signal indicating that the user is performing authorized fraud based on the current IPR (at block 1906). In some examples, the control signal causes the client server 140 to approve, hold, or deny the transfer of the electronic funds.

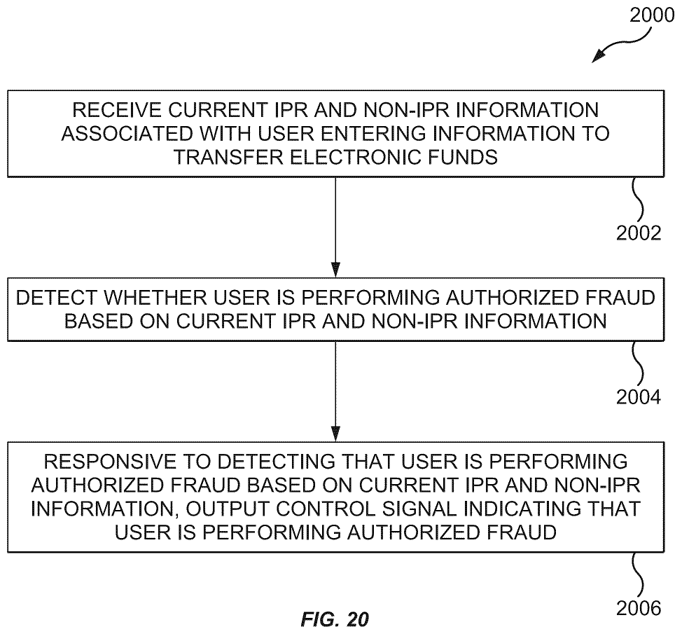

FIG. 20 is a flowchart illustrating a third example method 2000 for detecting authorized fraud, in accordance with various aspects of the present disclosure. FIG. 20 is described with respect to FIG. 1.

The method 2000 includes receiving, with the electronic processor, a current input profile record (IPR) and non-IPR information associated with a user entering information to transfer electronic funds (at block 2002). For example, the electronic processor 102 receives a current IPR and non-IPR information associated with a current user of the user interface device 120 from the client server 140.

The method 2000 includes detecting, with the electronic processor, whether the user is performing authorized fraud based on the current IPR and the non-IPR information (at block 2004).

The method 2000 includes responsive to detecting that the user is performing authorized fraud based on the current IPR and the non-IPR information, outputting, with the electronic processor, a control signal indicating that the user is performing authorized fraud based on the current IPR (at block 2006). In some examples, the control signal causes the client server 140 to approve, hold, or deny the transfer of the electronic funds.

The following are enumerated examples of devices, methods, computer-readable media, and systems with authorized fraud detection. Example 1: a server comprising: a memory including an input profile record (IPR) repository and a non-input profile record (non-IPR) information repository that is distinct from the IPR repository; and an electronic processor in communication with the memory, the electronic processor configured to receive a current IPR associated with a user entering information to transfer electronic funds, detect that the user is performing authorized fraud based on the current IPR, and responsive to detecting that the user is performing authorized fraud based on the current IPR, output a control signal indicating that the user is performing authorized fraud.

Example 2: the server of Example 1, wherein the current IPR includes a plurality of time-based events, a plurality of interaction-based events, or a combination thereof.

Example 3: the server of Example 2, wherein the plurality of time-based events includes a field blur (fb) event, a form focus (ff) event, a device motion (dms) event, a touch event (te), and a key down (kd) event.

Example 4: the server of Examples 2 or 3, wherein the plurality of interaction-based events includes a (mms) event), a (mm) event, and a mouse click (me) event.

Example 5: the server of Example 4, wherein the plurality of time-based events includes a touch event (te), a key up event (ku), a key down event (kd), a character count of a given field at a given time (kk) event, a form focus (ff) event, and a field blur (fb) event.

Example 6: the server of any of Examples 1-5, wherein, to detect that the user is performing the authorized fraud based on the current IPR, the electronic processor is further configured to: generate one or more time-based features, one or more distance-based features, or a combination thereof based on the current IPR, and determine that the one or more time-based features, the one or more distance-based features, or the combination thereof indicate that the user is performing the authorized fraud.

Example 7: the server of Example 6, wherein the one or more time-based features includes a number of key downs feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

Example 8: the server of Examples 6 or 7, wherein the one or more distance-based features includes a distance feature, a displacement element feature, a ratio of displacement to distance feature, or a combination thereof.

Example 9: a method comprising: receiving, with an electronic processor, a current IPR associated with a user entering information to transfer electronic funds; detecting, with the electronic processor, that the user is performing authorized fraud based on the current IPR; and responsive to detecting that the user is performing authorized fraud based on the current IPR, outputting, with the electronic processor, a control signal indicating that the user is performing authorized fraud.

Example 10: the method of Example 9, wherein the current IPR includes a plurality of time-based events, a plurality of interaction-based events, or a combination thereof.

Example 11: the method of Example 10, wherein the plurality of time-based events includes a field blur (fb) event, a form focus (ff) event, a device motion (dms) event, a touch event (te), and a key down (kd) event.

Example 12: the method of Examples 10 or 11, wherein the plurality of interaction-based events includes a (mms) event), a (mm) event, and a mouse click (me) event.

Example 13: the method of Example 12, wherein the plurality of time-based events includes a touch event (te), a key up event (ku), a key down event (kd), a character count of a given field at a given time (kk) event, a form focus (ff) event, and a field blur (fb) event.

Example 14: the method of any of Examples 9-14, wherein detecting that the user is performing the authorized fraud based on the current IPR further includes generating one or more time-based features, one or more distance-based features, or a combination thereof based on the current IPR, and determining that the one or more time-based features, the one or more distance-based features, or the combination thereof indicate that the user is performing the authorized fraud.

Example 15: the method of Example 14, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

Example 16: the method of Examples 14 or 15, wherein the one or more distance-based features includes a distance feature, a displacement element feature, a ratio of displacement to distance feature, or a combination thereof.

Example 17: a non-transitory computer-readable medium comprising instructions that, when executed by an electronic processor, cause the electronic processor to perform a set of operations comprising: receiving a current IPR associated with a user entering information to transfer electronic funds; detecting that the user is performing authorized fraud based on the current IPR; and responsive to detecting that the user is performing authorized fraud based on the current IPR, outputting a control signal indicating that the user is performing authorized fraud.

Example 18: the non-transitory computer-readable medium of Example 17, wherein the current IPR includes a plurality of time-based events, a plurality of interaction-based events, or a combination thereof.

Example 19: the non-transitory computer-readable medium of Example 18, wherein the plurality of time-based events includes a field blur (fb) event, a form focus (ff) event, a device motion (dms) event, a touch event (te), and a key down (kd) event.

Example 20: the non-transitory computer-readable medium of Examples 18 or 19, wherein the plurality of interaction-based events includes a (mms) event), a (mm) event, and a mouse click (me) event.

Example 21: the non-transitory computer-readable medium of Example 20, wherein the plurality of time-based events includes a touch event (te), a key up event (ku), a key down event (kd), a character count of a given field at a given time (kk) event, a form focus (ff) event, and a field blur (fb) event.

Example 22: the non-transitory computer-readable medium of any of Examples 17-21, wherein detecting that the user is performing the authorized fraud based on the current IPR further includes generating one or more time-based features, one or more distance-based features, or a combination thereof based on the current IPR, and determining that the one or more time-based features, the one or more distance-based features, or the combination thereof indicate that the user is performing the authorized fraud.

Example 23: the non-transitory computer-readable medium of Example 22, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

Example 24: the non-transitory computer-readable medium of Examples 22 or 23, wherein the one or more distance-based features includes a distance feature, a displacement element feature, a ratio of displacement to distance feature, or a combination thereof.

Example 25: a server comprising: a memory including an input profile record (IPR) repository and a non-input profile record (non-IPR) information repository that is distinct from the IPR repository; and an electronic processor in communication with the memory, the electronic processor configured to receive non-IPR information associated with a user entering information to transfer electronic funds, detect that the user is performing authorized fraud based on the non-IPR information, and responsive to detecting that the user is performing authorized fraud based on the non-IPR information, output a control signal indicating that the user is performing authorized fraud.

Example 26: the server of Example 25, wherein the non-IPR information includes transaction information, destination information, or a combination thereof.

Example 27: the server of Example 26, wherein, to detect that the user is performing the authorized fraud based on the non-IPR information, the electronic processor is further configured to: generate one or more transaction-only features, one or more destination-based features, or a combination thereof based on the non-IPR information, and determine that the one or more transaction-only features, the one or more destination-based features, or the combination thereof indicate that the user is performing the authorized fraud.

Example 28: the server of Example 27, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

Example 29: the server of Examples 27 or 28, wherein the one or more destination-based features includes a count_dest_global_req_90d feature, a count_dest_global_req_7d feature, a count_dest_global_accounts_90d feature, a count_dest_global_req_1h feature, or a combination thereof.

Example 30: a method comprising: receiving, with an electronic processor, non-IPR information associated with a user entering information to transfer electronic funds; detecting, with the electronic processor, that the user is performing authorized fraud based on the non-IPR information; and responsive to detecting that the user is performing authorized fraud based on the non-IPR information, outputting, with the electronic processor, a control signal indicating that the user is performing authorized fraud.

Example 31: the method of Example 30, wherein the non-IPR information includes transaction information, destination information, or a combination thereof.

Example 32: the method of Example 31, wherein detecting that the user is performing the authorized fraud based on the non-IPR information further includes generating one or more transaction-only features, one or more destination-based features, or a combination thereof based on the non-IPR information, and determining that the one or more transaction-only features, the one or more destination-based features, or the combination thereof indicate that the user is performing the authorized fraud.

Example 33: the method of Example 32, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

Example 34: the method of Examples 32 or 33, wherein the one or more destination-based features includes a count_dest_global_req_90d feature, a count_dest_global_req_7d feature, a count_dest_global_accounts_90d feature, a count_dest_global_req_1h feature, or a combination thereof.

Example 35: a non-transitory computer-readable medium comprising instructions that, when executed by an electronic processor, cause the electronic processor to perform a set of operations comprising: receiving non-IPR information associated with a user entering information to transfer electronic funds; detecting that the user is performing authorized fraud based on the non-IPR information; and responsive to detecting that the user is performing authorized fraud based on the non-IPR information, outputting a control signal indicating that the user is performing authorized fraud.

Example 36: the non-transitory computer-readable medium of Example 35, wherein the non-IPR information includes transaction information, destination information, or a combination thereof.

Example 37: the non-transitory computer-readable medium of Example 36, wherein detecting that the user is performing the authorized fraud based on the non-IPR information further includes generating one or more transaction-only features, one or more destination-based features, or a combination thereof based on the non-IPR information, and determining that the one or more transaction-only features, the one or more destination-based features, or the combination thereof indicate that the user is performing the authorized fraud.

Example 38: the non-transitory computer-readable medium of Example 37, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

Example 39: the non-transitory computer-readable medium of Examples 37 or 38, wherein the one or more destination-based features includes a count_dest_global_req_90d feature, a count_dest_global_req_7d feature, a count_dest_global_accounts_90d feature, a count_dest_global_req_1h feature, or a combination thereof.

Example 40: a server comprising: a memory including an input profile record (IPR) repository and a non-input profile record (non-IPR) information repository that is distinct from the IPR repository; and an electronic processor in communication with the memory, the electronic processor configured to receive a current IPR and non-IPR information associated with a user entering information to transfer electronic funds, detect that the user is performing authorized fraud based on the current IPR and the non-IPR information, and responsive to detecting that the user is performing authorized fraud based on the current IPR and the non-IPR information, output a control signal indicating that the user is performing authorized fraud.

Example 41: the server of Example 40, wherein the current IPR includes a plurality of time-based events, a plurality of interaction-based events, or a combination thereof.

Example 42: the server of Examples 40 or 41, wherein, to detect that the user is performing the authorized fraud based on the current IPR and the non-IPR information, the electronic processor is further configured to: generate one or more time-based features, one or more distance-based features, or a combination thereof based on the current IPR, determine that the one or more time-based features, the one or more distance-based features, or the combination thereof indicate that the user is performing the authorized fraud, generate one or more transaction-only features, one or more destination-based features, or a combination thereof based on the non-IPR information, and determine that the one or more transaction-only features, the one or more destination-based features, or the combination thereof indicate that the user is performing the authorized fraud.

Example 43: the server of Example 42, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

Example 44: the server of Examples 42 or 43, wherein the one or more distance-based features includes a distance feature, a displacement element feature, a ratio of displacement to distance feature, or a combination thereof.

Example 45: the server of any of Examples 42-44, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

Example 46: the server of any of Examples 42-46, wherein the one or more destination-based features includes a count_dest_global_req_90d feature, a count_dest_global_req_7d feature, a count_dest_global_accounts_90d feature, a count_dest_global_req_1h feature, or a combination thereof.

Example 47: a method comprising: receiving, with an electronic processor, a current IPR and non-IPR information associated with a user entering information to transfer electronic funds; detecting, with the electronic processor, that the user is performing authorized fraud based on the current IPR and the non-IPR information; and responsive to detecting that the user is performing authorized fraud based on the current IPR and the non-IPR information, outputting, with the electronic processor, a control signal indicating that the user is performing authorized fraud.

Example 48: the method of Example 47, wherein the current IPR includes a plurality of time-based events, a plurality of interaction-based events, or a combination thereof.

Example 49: the method of Examples 47 or 48, wherein detecting that the user is performing the authorized fraud based on the current IPR and the non-IPR information further includes generating one or more time-based features, one or more distance-based features, or a combination thereof based on the current IPR, determining that the one or more time-based features, the one or more distance-based features, or the combination thereof indicate that the user is performing the authorized fraud, generating one or more transaction-only features, one or more destination-based features, or a combination thereof based on the non-IPR information, and determining that the one or more transaction-only features, the one or more destination-based features, or the combination thereof indicate that the user is performing the authorized fraud.

Example 50: the method of Example 49, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

Example 51: the method of Examples 49 or 50, wherein the one or more distance-based features includes a distance feature, a displacement element feature, a ratio of displacement to distance feature, or a combination thereof.

Example 52: the method of any of Examples 49-51, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

Example 53: the method of any of Examples 49-52, wherein the one or more destination-based features includes a count_dest_global_req_90d feature, a count_dest_global_req_7d feature, a count_dest_global_accounts_90d feature, a count_dest_global_req_1h feature, or a combination thereof.

Example 54: a non-transitory computer-readable medium comprising instructions that, when executed by an electronic processor, cause the electronic processor to perform a set of operations comprising: receiving a current IPR and non-IPR information associated with a user entering information to transfer electronic funds; detecting that the user is performing authorized fraud based on the current IPR and the non-IPR information; and responsive to detecting that the user is performing authorized fraud based on the current IPR and the non-IPR information, outputting a control signal indicating that the user is performing authorized fraud.

Example 55: the non-transitory computer-readable medium of Example 54, wherein the current IPR includes a plurality of time-based events, a plurality of interaction-based events, or a combination thereof.

Example 56: the non-transitory computer-readable medium of Examples 54 or 55, wherein detecting that the user is performing the authorized fraud based on the current IPR and the non-IPR information further includes generating one or more time-based features, one or more distance-based features, or a combination thereof based on the current IPR, determining that the one or more time-based features, the one or more distance-based features, or the combination thereof indicate that the user is performing the authorized fraud, generating one or more transaction-only features, one or more destination-based features, or a combination thereof based on the non-IPR information, and determining that the one or more transaction-only features, the one or more destination-based features, or the combination thereof indicate that the user is performing the authorized fraud.

Example 57: the non-transitory computer-readable medium of Example 56, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

Example 58: the non-transitory computer-readable medium of Examples 56 or 57, wherein the one or more distance-based features includes a distance feature, a displacement element feature, a ratio of displacement to distance feature, or a combination thereof.

Example 59: the non-transitory computer-readable medium of any of Examples 56-58, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

Example 60: the non-transitory computer-readable medium of any of Examples 56-59, wherein the one or more destination-based features includes a count_dest_global_req_90d feature, a count_dest_global_req_7d feature, a count_dest_global_accounts_90d feature, a count_dest_global_req_1h feature, or a combination thereof.

Example 61: a system comprising: a client server; Examples 1-8; Examples 25-29; Examples 40-46; or a combination thereof, wherein the respective control signals causes the client server to approve, hold, or deny an electronic transaction.

Thus, the present disclosure provides, among other things, devices, methods, computer-readable media, and systems with authorized fraud detection. Various features and advantages of the invention are set forth in the following claims.

What is claimed is:

1. A server comprising:
a memory including an input profile record (IPR) repository and a non-input profile record (non-IPR) information repository that is distinct from the IPR repository; and
an electronic processor in communication with the memory, the electronic processor configured to
receive a current IPR associated with a user entering information to transfer electronic funds,
detect that the user is performing authorized fraud based on the current IPR, and
responsive to detecting that the user is performing authorized fraud based on the current IPR, output a control signal indicating that the user is performing authorized fraud.

2. The server of claim 1, wherein the current IPR includes a plurality of time-based events, a plurality of interaction-based events, or a combination thereof.

3. The server of claim 2, wherein the plurality of time-based events includes a field blur (fb) event, a form focus (ff) event, a device motion (dms) event, a touch event (te), and a key down (kd) event.

4. The server of claim 2, wherein the plurality of interaction-based events includes a (mms) event), a (mm) event, and a mouse click (me) event.

5. The server of claim 4, wherein the plurality of time-based events includes a touch event (te), a key up event (ku), a key down event (kd), a character count of a given field at a given time (kk) event, a form focus (ff) event, and a field blur (fb) event.

6. The server of claim 1, wherein, to detect that the user is performing the authorized fraud based on the current IPR, the electronic processor is further configured to:
generate one or more time-based features, one or more distance-based features, or a combination thereof based on the current IPR, and
determine that the one or more time-based features, the one or more distance-based features, or the combination thereof indicate that the user is performing the authorized fraud.

7. The server of claim 6, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

8. The server of claim 6, wherein the one or more distance-based features includes a distance feature, a displacement element feature, a ratio of displacement to distance feature, or a combination thereof.

9. A server comprising:
a memory including an input profile record (IPR) repository and a non-input profile record (non-IPR) information repository that is distinct from the IPR repository; and
an electronic processor in communication with the memory, the electronic processor configured to
receive non-IPR information associated with a user entering information to transfer electronic funds,
detect that the user is performing authorized fraud based on the non-IPR information, and
responsive to detecting that the user is performing authorized fraud based on the non-IPR information, output a control signal indicating that the user is performing authorized fraud.

10. The server of claim 9, wherein the non-IPR information includes transaction information, destination information, or a combination thereof.

11. The server of claim 10, wherein, to detect that the user is performing the authorized fraud based on the non-IPR information, the electronic processor is further configured to:
generate one or more transaction-only features, one or more destination-based features, or a combination thereof based on the non-IPR information, and
determine that the one or more transaction-only features, the one or more destination-based features, or the combination thereof indicate that the user is performing the authorized fraud.

12. The server of claim 11, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

13. The server of claim 11, wherein the one or more destination-based features includes a count_dest_global_req_90d feature, a count_dest_global_req_7d feature, a count_dest_global_accounts_90d feature, a count_dest_global_req_1h feature, or a combination thereof.

14. A server comprising:
a memory including an input profile record (IPR) repository and a non-input profile record (non-IPR) information repository that is distinct from the IPR repository; and
an electronic processor in communication with the memory, the electronic processor configured to
receive a current IPR and non-IPR information associated with a user entering information to transfer electronic funds,
detect that the user is performing authorized fraud based on the current IPR and the non-IPR information, and
responsive to detecting that the user is performing authorized fraud based on the current IPR and the non-IPR information, output a control signal indicating that the user is performing authorized fraud.

15. The server of claim 14, wherein the current IPR includes a plurality of time-based events, a plurality of interaction-based events, or a combination thereof.

16. The server of claim 14, wherein, to detect that the user is performing the authorized fraud based on the current IPR and the non-IPR information, the electronic processor is further configured to:
generate one or more time-based features, one or more distance-based features, or a combination thereof based on the current IPR,
determine that the one or more time-based features, the one or more distance-based features, or the combination thereof indicate that the user is performing the authorized fraud,
generate one or more transaction-only features, one or more destination-based features, or a combination thereof based on the non-IPR information, and
determine that the one or more transaction-only features, the one or more destination-based features, or the combination thereof indicate that the user is performing the authorized fraud.

17. The server of claim 16, wherein the one or more time-based features includes a number of keydowns feature, a field blur to dms time (max) feature, a kd to dms time (max) feature, a time between kds (median) feature, a time between form focus (median) feature, a time between touch (avg) feature, a te to dms time (max) feature, a time between kds (max) feature, a kd to te time (max) feature, a te to kd time (max) feature, or a combination thereof.

18. The server of claim 16, wherein the one or more distance-based features includes a distance feature, a displacement element feature, a ratio of displacement to distance feature, or a combination thereof.

19. The server of claim 16, wherein the one or more transaction-only features includes a is_dest_seen_before feature, a is_dest_phone feature, a delta_hours_last_addrecipientnma feature, a current_transfer_amt feature, a delta_hours_last_addrecipient feature, a count_addrecipientnma_1h feature, a count_addrecipientnma_30m feature, a count_addrecipient_1h feature, a diff_hist_current_transfer_amt feature, a count_addrecipient_30m feature, a count_sendfundsnma_5m feature, a count_addrecipient_5m feature, a current_transfer_num_zeros feature, a count_addrecipientmma_90d feature, a count_addrecipientmma_30d feature, a count_sendfundsnma_30d feature, a count_addrecipientmma_7d feature, a count_sendfunds_30d feature, a delta_hours_last_sendfundsnma feature, a prop_is_source_seen_before feature, or a combination thereof.

20. The server of claim 16, wherein the one or more destination-based features includes a count_dest_global_req_90d feature, a count_dest_global_req_7d feature, a count_dest_global_accounts_90d feature, a count_dest_global_req_1h feature, or a combination thereof.
